(19) United States
(12) Patent Application Publication
(10) Pub. No.: US 2019/0322267 A1
(43) Pub. Date: Oct. 24, 2019

(54) CONTROL DEVICE OF HYBRID VEHICLE

(71) Applicant: TOYOTA JIDOSHA KABUSHIKI KAISHA, Toyota-shi (JP)

(72) Inventor: Sui KURIHASHI, Susono-shi (JP)

(73) Assignee: TOYOTA JIDOSHA KABUSHIKI KAISHA, Toyota-shi (JP)

(21) Appl. No.: 16/297,847

(22) Filed: Mar. 11, 2019

(30) Foreign Application Priority Data
Apr. 19, 2018 (JP) 2018-080852

(51) Int. Cl. B60W 20/12; B60K 6/40; B60W 10/06; B60W 10/08; B60W 20/13

(52) U.S. Cl. CPC B60W 20/12; B60K 6/40; B60W 10/06; B60W 10/08; B60Y 2300/91; B60W 2710/06; B60W 2710/08; B60W 2510/244; B60Y 2200/92; B60W 20/13

(57) ABSTRACT

A control device of a hybrid vehicle 1, 1′ comprises a driving plan generating part configured to set in advance a driving mode when the hybrid vehicle is being driven; and an output control part configured to control outputs of the internal combustion engine and the motor based on the driving mode. If the hybrid vehicle is being driven from a departure point through at least one via point to a final destination, the driving plan generating part is configured to divide a plurality of routes each having a via point as at least one of a starting point and an end point into pluralities of sections, calculate an amount of electric power chargeable to the battery while the hybrid vehicle is being driven, and set driving modes of all sections of at least one route to an EV mode based on the amount of electric power.

### FIELD

The present invention relates to a control device of a hybrid vehicle.

### BACKGROUND

Known in the past has been a hybrid vehicle provided with an internal combustion engine, a motor, and a battery supplying electric power to the motor and able to be charged by output of the internal combustion engine. In such a hybrid vehicle, an EV mode in which drive use power is output by only the motor can be selected as the driving mode.

In the EV mode, the internal combustion engine is stopped, so by setting the driving mode to the EV mode, it is possible to improve the fuel efficiency of the hybrid vehicle. In the hybrid vehicle described in PTL 1, a route until the destination is divided in a plurality of sections and the driving modes in sections with a high EV suitability are preferentially set to the EV mode.

### CITATIONS LIST

### Patent Literature

[PTL 1] Japanese Unexamined Patent Publication No. 2014-162261A

### SUMMARY

### Technical Problem

In this regard, if the hybrid vehicle is driven from a departure point through a via point to a final destination, often the temperature of the internal combustion engine will fall while the vehicle is stopped at the via point. If the temperature of the internal combustion engine falls, a catalyst has to be warmed up at the time of restart of the internal combustion engine and fuel is excessively consumed for warming up the catalyst.

For this reason, even if the ratio by which the EV mode is selected as the driving mode is made higher, if the number of times of warm-up of the catalyst is high, sometimes the fuel efficiency deteriorates. However, in the hybrid vehicle described in PTL 1, the fuel consumed for warming up the catalyst is not considered at all when selecting of the driving modes at the sections.

Therefore, in consideration of the above problem, an object of the present invention is to reduce the number of times of warm-up of a catalyst provided in an exhaust passage of an internal combustion engine when a hybrid vehicle is being driven from a departure point through a via point to a final destination.

### Solution to Problem

The summary of the present disclosure is as follows.

(1) A control device of a hybrid vehicle for controlling a hybrid vehicle comprising an internal combustion engine in which a catalyst is provided in an exhaust passage, a motor, and a battery supplying electric power to the motor and able to be charged by output of the internal combustion engine, the control device of a hybrid vehicle comprising: a driving plan generating part configured to set in advance a driving mode when the hybrid vehicle is being driven; and an output control part configured to control outputs of the internal combustion engine and the motor based on the driving mode, wherein if the hybrid vehicle is being driven from a departure point through at least one via point to a final destination, the driving plan generating part is configured to divide a plurality of routes each having a via point as at least one of a starting point and an end point into pluralities of sections, calculate an amount of electric power chargeable to the battery while the hybrid vehicle is being driven, and set driving modes of all sections of at least one route to an EV mode in which the internal combustion engine is stopped and drive use power is output by only the motor, based on the amount of electric power.

(2) The control device of a hybrid vehicle described in above (1), wherein the driving plan generating part is configured to set the driving modes of all sections of at least one route to the EV mode based on a state of charge of the battery at the departure point, and set to the EV mode the driving modes of all sections of routes other than the routes in which the driving modes of all sections are set to the EV mode, based on the amount of electric power.

(3) The control device of a hybrid vehicle described in above (1) or (2), wherein the driving plan generating part is configured to calculate the amount of electric power as a total of the electric power able to be charged to the battery by output of the internal combustion engine while the hybrid vehicle is being driven.

(4) The control device of a hybrid vehicle described in above (3), wherein the driving plan generating part is configured to calculate the amount of electric power as a total of the electric power chargeable to the battery when setting the driving modes of some of the sections to an RE mode where the internal combustion engine is operated so as to charge the battery and the engine load is maintained at a predetermined value.

(5) The control device of a hybrid vehicle described in above (3), wherein the driving plan generating part is configured to set the driving modes of some of the sections to an HV mode where drive-use power is output by the internal combustion engine and the motor and the outputs of the internal combustion engine and the motor are controlled so that the SOC of the battery approaches a target state of charge, and calculate the amount of electric power as a total of electric power chargeable to the battery when making the target state of charge at end points of the sections higher than the target state of charge at starting points of the sections.

(6) The control device of a hybrid vehicle described in above (1) or (2), wherein the battery can be charged by regenerative energy, and the driving plan generating part is configured to calculate the amount of electric power as a total of the electric power chargeable to the battery by regenerative energy while the hybrid vehicle is being driven.

(7) The control device of a hybrid vehicle described in any one of above (1) to (6), wherein the driving plan generating part is configured to generate a plurality of driving plans with different numbers of routes in which driving modes of all sections are set to the EV mode, and the output control part is configured to control outputs of the internal combustion engine and the motor based on a driving plan where the amount of fuel consumed at the internal combustion engine becomes the smallest.

### Advantageous Effects of Invention

According to the present invention, it is possible to reduce the number of times of warm-up of a catalyst provided in an exhaust passage of an internal combustion engine when a hybrid vehicle is being driven from a departure point through a via point to a final destination.

### BRIEF DESCRIPTION OF DRAWINGS

FIG. 1 is a view schematically showing the configuration of a hybrid vehicle according to a first embodiment of the present invention.

FIG. 2 is a block diagram schematically showing the configuration of a control device etc. of the hybrid vehicle according to the first embodiment of the present invention.

FIG. 3A is a flow chart showing a control routine of processing for generating a driving plan in the first embodiment of the present invention.

FIG. 3B is a flow chart showing the control routine of the processing for generating the driving plan in the first embodiment of the present invention.

FIG. 3C is a flow chart showing the control routine of the processing for generating the driving plan in the first embodiment of the present invention.

FIG. 4A is a view for explaining the generation of a first driving plan.

FIG. 4B is a view for explaining the generation of the first driving plan.

FIG. 4C is a view for explaining the generation of the first driving plan.

FIG. 5A is a view for explaining the generation of a second driving plan.

FIG. 5B is a view for explaining the generation of the second driving plan.

FIG. 5C is a view for explaining the generation of the second driving plan.

FIG. 5D is a view for explaining the generation of the second driving plan.

FIG. 6A is a view for explaining the generation of a third driving plan.

FIG. 6B is a view for explaining the generation of the third driving plan.

FIG. 7A is a flow chart showing a control routine of processing for generating a driving plan in a second embodiment of the present invention.

FIG. 7B is a flow chart showing the control routine of the processing for generating the driving plan in the second embodiment of the present invention.

FIG. 7C is a flow chart showing the control routine of the processing for generating the driving plan in the second embodiment of the present invention.

FIG. 7D is a flow chart showing the control routine of the processing for generating the driving plan in the second embodiment of the present invention.

FIG. 8 is a view for explaining the generation of a first driving plan.

FIG. 9 is a view for explaining the generation of a second driving plan.

FIG. 10A is a view for explaining the generation of a third driving plan.

FIG. 10B is a view for explaining the generation of the third driving plan.

FIG. 11 is a block diagram schematically showing the configuration of a control device etc. of a hybrid vehicle according to a third embodiment of the present invention.

### DESCRIPTION OF EMBODIMENTS

Below, referring to the drawings, embodiments of the present invention will be explained in detail. Note that, in the following explanation, similar components are assigned the same reference signs.

### First Embodiment

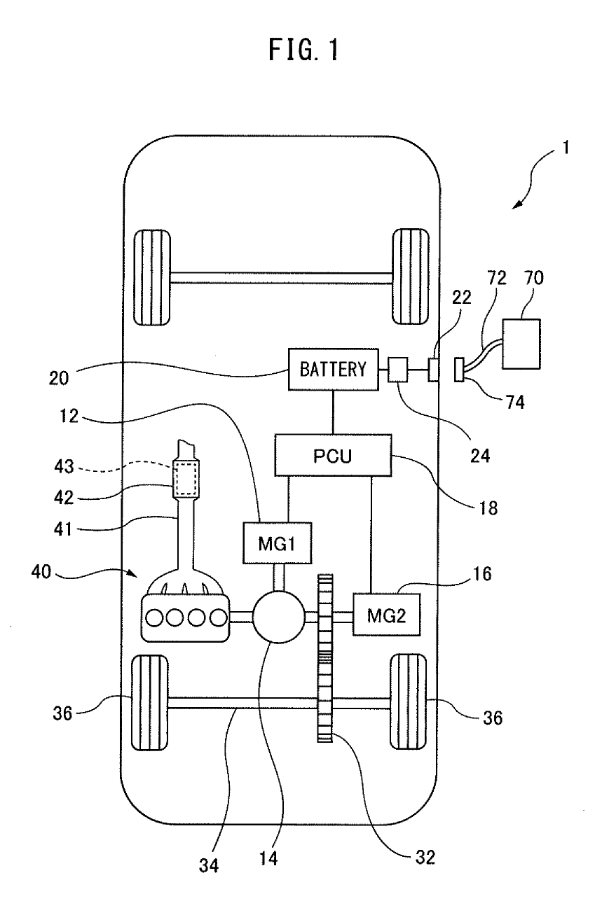

Below, referring to FIG. 1 to FIG. 6B, a first embodiment of the present invention will be explained.

<Configuration of Hybrid Vehicle>

FIG. 1 is a view schematically showing the configuration of a hybrid vehicle I according to the first embodiment of the present invention. A hybrid vehicle (below, simply referred to as the “vehicle”) 1 is provided with an internal combustion engine 40, first motor-generator 12, power distributing mechanism 14, second motor-generator 16, power control unit (PCU) 18, and battery 20.

The internal combustion engine 40 makes a mixture of fuel and air burn in a cylinder to output drive power. The internal combustion engine 40 is, for example, a gasoline engine or diesel engine. In the exhaust passage 41 of the internal combustion engine 40, a catalyst 43 housed in a casing 42 is provided. The catalyst 43 is, for example, a three-way catalyst, NO_{X} storage and reduction catalyst, selective reduction type NO_{X} reducing catalyst (SCR catalyst), etc. The output shaft (crankshaft) of the internal combustion engine 40 is mechanically connected to a power dividing mechanism 14. The output of the internal combustion engine 40 is input to the power dividing mechanism 14.

The first motor-generator 12 functions as a generator and motor. The first motor-generator 12 is mechanically connected to the power distributing mechanism 14, and the output of the first motor-generator 12 is input to the power distributing mechanism 14. Further, the first motor-generator 12 is electrically connected to the PCU 18. When the first motor-generator 12 functions as a generator, the electric power generated by the first motor-generator 12 is supplied through the PCU 18 to at least one of the second motor-generator 16 and battery 20. On the other hand, when the first motor-generator 12 functions as a motor, the electric power stored in the battery 20 is supplied through the PCU 18 to the first motor-generator 12.

The power distributing mechanism 14 is configured as a known planetary gear mechanism including a sun gear, ring gear, pinion gears, and a planetary carrier. The output shaft of the internal combustion engine 40 is coupled with the planetary carrier, the first motor-generator 12 is coupled with the sun gear, and a speed reducer 32 is coupled with the ring gear, The power distributing mechanism 14 distributes the output of the internal combustion engine 40 to the first motor-generator 12 and the speed reducer 32.

Specifically, when the first motor-generator 12 functions as a generator, the output of the internal combustion engine 40 input to the planetary carrier is distributed to the sun gear coupled with the first motor-generator 12 and the ring gear coupled with the speed reducer 32 in accordance with the gear ratio. The output of the internal combustion engine 40 distributed to the first motor-generator 12 is used to generate electric power by the first motor-generator 12. On the other hand, the output of the internal combustion engine 40 distributed to the speed reducer 32 is transmitted as power for driving use through an axle 34 to the wheels 36. Therefore, the internal combustion engine 40 can output power for driving use. Further, when the first motor-generator 12 functions as a motor, the output of the first motor-generator 12 is supplied through the sun gear and planetary carrier to the output shaft of the internal combustion engine 40 whereby the internal combustion engine 40 is cranked.

The second motor-generator 16 functions as a generator and motor. The second motor-generator 16 is mechanically connected to the speed reducer 32, and the output of the second motor-generator 16 is supplied to the speed reducer 32. The output of the second motor-generator 16 supplied to the speed reducer 32 is transmitted as power for driving use to the wheels 36 through the axle 34. Therefore, the second motor-generator 16 can output power for driving use.

Further, the second motor-generator 16 is electrically connected to the PCU 18. At the time of deceleration of the vehicle 1, due to rotation of the wheels 36, the second motor-generator 16 is driven and the second motor-generator 16 functions as a generator. As a result, so-called regeneration is performed. When the second motor-generator 16 functions as a generator, the regenerative power generated by the second motor-generator 16 is supplied through the PCU 18 to the battery 20. On the other hand, when the second motor-generator 16 functions as a motor, the power stored in the battery 20 is supplied through the PCU 18 to the second motor-generator 16.

The PCU 18 is electrically connected to the first motor-generator 12, second motor-generator 16, and battery 20. The PCU 18 includes an inverter, a booster converter, and a DC-DC converter. The inverter converts DC power supplied from the battery 20 to AC power and converts AC power generated by the first motor-generator 12 or second motor-generator 16 to DC power. The booster converter boosts the voltage of the battery 20 in accordance with need when the power stored in the battery 20 is supplied to the first motor-generator 12 or the second motor-generator 16. The DC-DC converter lowers the voltage of the battery 20 when the electric power stored in the battery 20 is supplied to the headlights or other electronic equipment.

The battery 20 is supplied with the electric power generated by the first motor-generator 12 using the output of the internal combustion engine 40 and the regenerative electric power generated by the second motor-generator 16 using the regenerative energy. Therefore, the battery 20 can be charged by the output of the internal combustion engine 40 and the regenerative energy. The battery 20 is for example a lithium ion battery, nickel hydrogen battery, or other secondary battery.

The vehicle 1 is further provided with a charging port 22 and charger 24. The battery 20 can be charged by an external power source 70 as well. Therefore, the vehicle 1 is a so-called “plug-in hybrid vehicle”.

The charging port 22 is configured so as to receive the electric power from the external power source 70 through a charging connector 74 of a charging cable 72. When the battery 20 is charged by the external power source 70, the charging connector 74 is connected to the charging port 22. The charger 24 converts the electric power supplied from the external power source 70 to electric power which can be supplied to the battery 20. Note that, the charging port 22 may also be connected to the PCU 18, and the PCU 18 may also function as the charger 24.

<Control Device of Hybrid Vehicle>

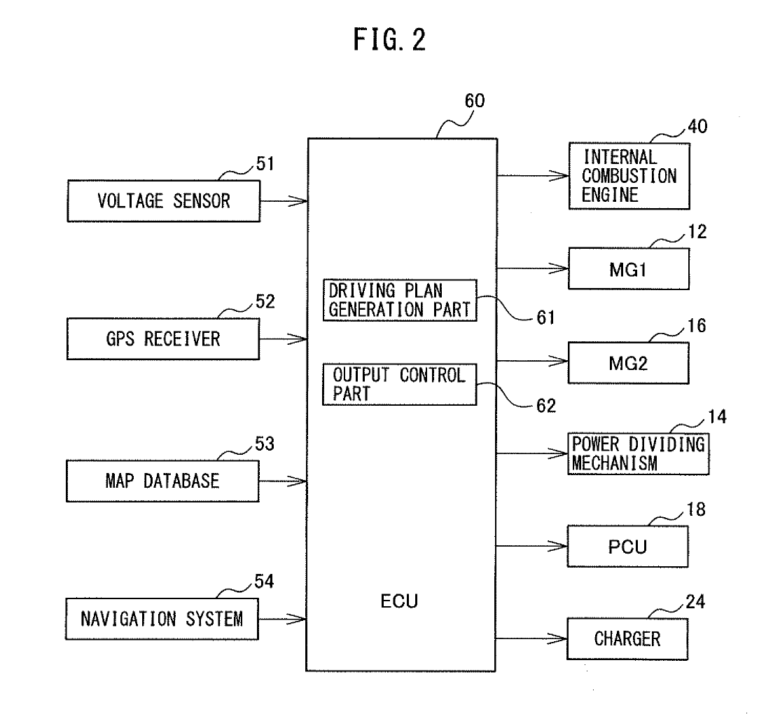

FIG. 2 is a block diagram schematically showing the configuration of a control device etc., of a hybrid vehicle according to a first embodiment of the present invention. The vehicle 1 is provided with an electronic control unit (ECU) 60. The ECU 60 is an electronic control device controlling the vehicle 1. The ECU 60 is provided with a read only memory (ROM) and random access memory (RAM) or other such memory, a central processing unit (CPU), input port, output port, communication module, etc. In the present embodiment, a single ECU 60 is provided, but a plurality of ECUs may be provided for the different functions.

The outputs of various sensors provided at the vehicle 1 are input to the ECU 60. For example, in the present embodiment, the outputs of a voltage sensor 51 and a OPS receiver 52 are input to the ECU 60.

The voltage sensor 51 is provided at the battery 20 and detects the voltage across the electrodes of the battery 20. The voltage sensor 51 is connected to the ECU 60, so the output of the voltage sensor 51 is transmitted to the ECU 60. The ECU 60 calculates the state of charge (SOC: State Of Charge) of the battery 20 based on the output of the voltage sensor 51, etc.

The GPS receiver 52 receives signals from three or more GPS satellites and detects the current position of the vehicle 1 (for example, the longitude and latitude of the vehicle 1). The GPS receiver 52 is connected to the ECU 60, so the output of the GPS receiver 52 is transmitted to the ECU 60.

Further, the ECU 60 is connected to a map database 53 provided at the vehicle 1. The map database 53 is a database relating to the map information. The map information includes road information such as positional information of roads, shape information of roads (for example curved or straight, the radius of curvature of curves, the road gradients, etc.), the types of roads, the speed limits, and other information. The ECU 60 acquires map information from the map database 53.

Further, the ECU 60 is connected to a navigation system 54 provided at the vehicle 1. The navigation system 54 sets the driving route of the vehicle 1 up to the destination based on the current position of the vehicle 1 detected by the GPS receiver 52, the map information of the map database 53, input by the driver, etc. The driving route set by the navigation system 54 is transmitted to the ECU 60. Note that, the GPS receiver 52 and map database 53 may be built into the navigation system 54.

The ECU 60 is connected to the internal combustion engine 40, first motor-generator 12, second motor-generator 16, power dividing mechanism 14, PCU 18, and charger 24, and controls the same. In the present embodiment, the ECU 60 runs programs etc., stored in the memory to thereby function as a driving plan generating part 61 and an output control part 62. Therefore, the control device of the vehicle 1 is provided with the driving plan generating part 61 and output control part 62.

The driving plan generating part 61 sets in advance a driving mode and a target SOC of the battery 20 when the vehicle 1 is being driven. The output control part 62 controls the outputs of the internal combustion engine 40 and second motor-generator 16 based on the driving mode. The driving plan generating part 61 selects the EV (electric vehicle) mode or HV (hybrid vehicle) mode as the driving mode.

In the EV mode, the internal combustion engine 40 is stopped and drive use power is output by only the second motor-generator 16. For this reason, in the EV mode, electric power is supplied from the battery 20 to the second motor-generator 16. As a result, in the EV mode, the amount of electric power of the battery 20 decreases and the SOC of the battery 20 falls. Note that, a one-way clutch transmitting rotational force in only one direction is provided at the power dividing mechanism 14. In the EV mode, drive use power may be output by the first motor-generator 12 and the second motor-generator 16.

On the other hand, in the HV mode, drive use power is output by the internal combustion engine 40 and the second motor-generator 16, and outputs of the internal combustion engine 40 and the second motor-generator 16 are controlled so that the SOC of the battery 20 approaches the target SOC. In the HV mode, basically, the electric power generated by the first motor-generator 12 using the output of the internal combustion engine 40 is supplied to the second motor-generator 16 and the supply of electric power from the battery 20 is stopped. Note that, in the HV mode, the battery 20 may temporarily be charged by the output of the internal combustion engine 40 or electric power may temporarily be supplied from the battery 20 to the second motor-generator 16. In the HV mode, the amount of electric power and SOC of the battery 20 are maintained substantially constant. Therefore, the degree of drop of the SOC in the HV mode is smaller than the degree of drop of the SOC in the EV mode.

In the HV mode, fuel is consumed in the internal combustion engine 40. In the EV mode, fuel is not consumed in the internal combustion engine 40. For this reason, in order to improve the fuel efficiency of the vehicle 1, it is desirable to maintain the driving mode at the EV mode as much as possible. However, if the SOC of the battery 20 is low, it is not possible to set the driving mode to the EV mode. For this reason, if driving the vehicle 1 for a long period of time without charging the battery 20 by the external power supply 70, it is necessary to jointly use the EV mode and HV mode as the driving mode.

The heat efficiency of the internal combustion engine 40 usually becomes lower when the engine load is low. For this reason, at a section with a low driving load, for example, a section with many traffic lights or a section in which congestion easily occurs, it is desirable to set the driving mode to the EV mode and make the internal combustion engine 40 stop. On the other hand, at a section with a high driving load, for example, a highway, ascending slope, etc., it is desirable to set the driving mode to the HV mode.

Further, charging of the battery 20 by the outside power supply 70 is not necessarily performed every one trip (time period from when ignition switch of vehicle 1 is turned on to when it is turned off). For this reason, sometimes several trips are required until the battery 20 is charged by the outside power supply 70 at the final destination (for example home). For example, if going back and forth between the home and workplace, the workplace becomes the via point and two trips are required. Further, if returning from the home to the home through two destinations (shopping center etc.), the destinations become via points and three trips are required.

If the vehicle 1 is driven from the departure point through a via point to the final destination, often the temperature of the internal combustion engine 40 will fall while stopped at the via point. If the temperature of the internal combustion engine 40 falls, the catalyst 43 has to be warmed up at the time of restart of the internal combustion engine 40 and fuel is excessively consumed for warming up the catalyst 43.

For this reason, even if the ratio by which the EV mode is selected as the driving mode is made higher, if the number of times of warm-up of the catalyst 43 is large, sometimes the fuel efficiency deteriorates. Therefore, in the present embodiment, the driving mode is set so that the fuel efficiency of the driving route as a whole is optimized considering also the fuel consumed for warming up the catalyst 43.

Specifically, if the vehicle 1 is driven from the departure point through at least one via point to the final destination, the driving plan generating part 61 divides a plurality of routes having a via point as at least one of the starting point and end point into pluralities of sections, and sets driving modes of all sections of at least one route to an EV mode. In the EV route in which the driving modes of all sections are set to the EV mode, the internal combustion engine 40 is not started up, so the catalyst 43 is not warmed up. For this reason, by setting the driving modes of all sections of at least one route to the EV mode, if the vehicle 1 is driven from the departure point through at least one via point to the final destination, the number of times of warmup of the catalyst 43 can be reduced.

In the present embodiment, the driving plan generating part 61 generates a first driving plan, second driving plan, and third driving plan. The first driving plan, second driving plan, and third driving plan are generated so as to have numbers of EV routes differing from each other,

When generating the first driving plan, the driving plan generating part 61 preferentially sets driving modes of sections with high EV suitabilities to the EV mode based on the SOC of the battery 20 at the departure point. The driving plan generating part 61 calculates the EV suitabilities of the sections and assigns the SOC of the battery 20 at the departure point in order from the section with the highest EV suitability down. For this reason, at the first driving plan, the number of times of warm-up of the catalyst 43 is not considered. The EV suitability is an indicator showing the degree of suitability to the EV mode and is made higher the lower the driving load.

The driving plan generating part 61 sets the driving modes of all sections of at least one route to the EV mode based on the SOC of the battery 20 at the departure point when generating the second driving plan. By doing this, it is possible to reduce the number of times of warm-up of the catalyst 43 when the vehicle 1 is being driven from the departure point through at least one via point to the final destination. The driving plan generating part 61 calculates the amount of power consumption when the vehicle 1 is being driven over the route by the EV mode and assigns the SOC of the battery 20 at the departure point in order from the route with the smallest amount of power consumption on up. For this reason, in the second driving plan, the routes are set to EV routes in order from the route with the smallest amount of power consumption up.

Further, when the driving load is low, it is possible to raise the output of the internal combustion engine 40 to thereby charge the electric power generated using the output of the internal combustion engine 40 in the battery 20. If the battery 20 is charged while the vehicle 1 is being driven, the amount of electric power which can be used in the EV mode becomes greater. For this reason, sometimes it is possible to charge the battery 20 on a predetermined route so as to make the number of EV routes increase.

Therefore, the driving plan generating part 61 calculates the amount of electric power which can be charged to the battery 20 while the vehicle 1 is being driven (below, referred to as “the amount of chargeable electric power”) and sets the driving modes of all of the sections of at least one route to the EV mode based on the amount of chargeable electric power. By doing this, it is possible to reduce the number of times of warm-up of the catalyst 43 in the case where the vehicle 1 is driven from a departure point through at least one via point to the final destination. Note that, the amount of chargeable electric power is the amount of electric power which can be charged to the battery 20 from when the vehicle 1 leaves the departure point to when it arrives at the final destination.

When generating the third driving plan, the driving plan generating part 61 sets to the EV mode the driving modes of all sections of non-EV routes other than the EV routes where the driving modes of all sections are set to the EV mode based on the amount of chargeable electric power. By doing this, it is possible to further reduce the number of times of warm-up of the catalyst 43.

The driving plan generating part 61 can select an RE (range extender) mode as the driving mode. In the RE mode, the internal combustion engine 40 is operated so as to charge the battery 20 and the engine load is maintained at a predetermined value. The predetermined value is preset and is set so that the heat efficiency of the internal combustion engine 40 becomes higher.

In the RE mode, the output of the internal combustion engine 40 is used as the driving-use power and the supply of electric power from the battery 20 is stopped. In the RE mode, the battery 20 is charged by the electric power generated using the output of the internal combustion engine 40 in accordance with the driving load. For this reason, in the RE mode, basically, the amount of electric power of the battery 20 increases and the SOC of the battery 20 rises. Note that, the RE mode is also called the “SOC restoration mode”.

In the present embodiment, the driving plan generating part 61 calculates the amount of chargeable electric power as the total of the electric power which can be charged to the battery 20 by the output of the internal combustion engine 40 while the vehicle 1 is being driven. Specifically, the driving plan generating part 61 calculates the amount of chargeable electric power as the total of the electric power which can be charged to the battery 20 when setting the driving modes of some of the sections to the RE mode.

If the amount of electric power which can be charged to the battery 20 in a second non-EV route set to a non-EV route in the first driving plan or second driving plan is larger than the amount of electric power required for changing a first non-EV route set to a non-EV route in the first driving plan or second driving plan to an EV route, the driving plan generating part 61 charges the battery 20 by the RE mode in the second non-EV route and changes the first non-EV route to an EV route. The amount of power consumption when the vehicle 1 is being driven by the EV mode over the first non-EV route is equal to or less than the amount of power consumption when the vehicle 1 is being driven by the EV mode over the second non-EV route.

Basically, when the vehicle 1 is being driven from a departure point through a via point to a final destination, the higher the ratio of the EV routes in the driving route, the smaller the number of times of warm-up of the catalyst 43 and the smaller the amount of fuel consumed at the internal combustion engine 40. For this reason, in order to improve the fuel efficiency of the vehicle 1, it is advantageous to employ a third driving plan as the final driving plan. However, depending on the driving loads of the sections etc., sometimes the amount of total fuel consumption of the first driving plan or second driving plan becomes smaller than the amount of total fuel consumption of the third driving plan.

For this reason, the output control part 62 controls the outputs of the internal combustion engine 40 and second motor generator 16 based on the driving plan where the amount of fuel consumed at the internal combustion engine 40 becomes the smallest. By doing this, the fuel efficiency of the vehicle 1 can be improved more effectively.

<Processing for Generating Driving Plan>

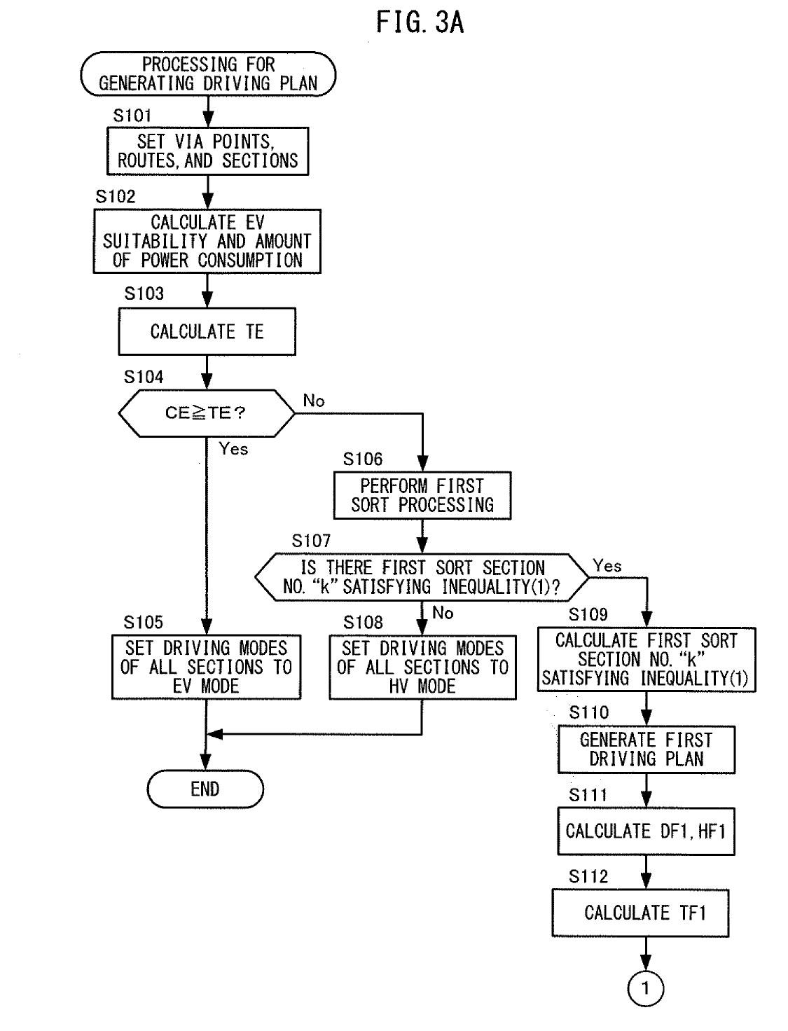

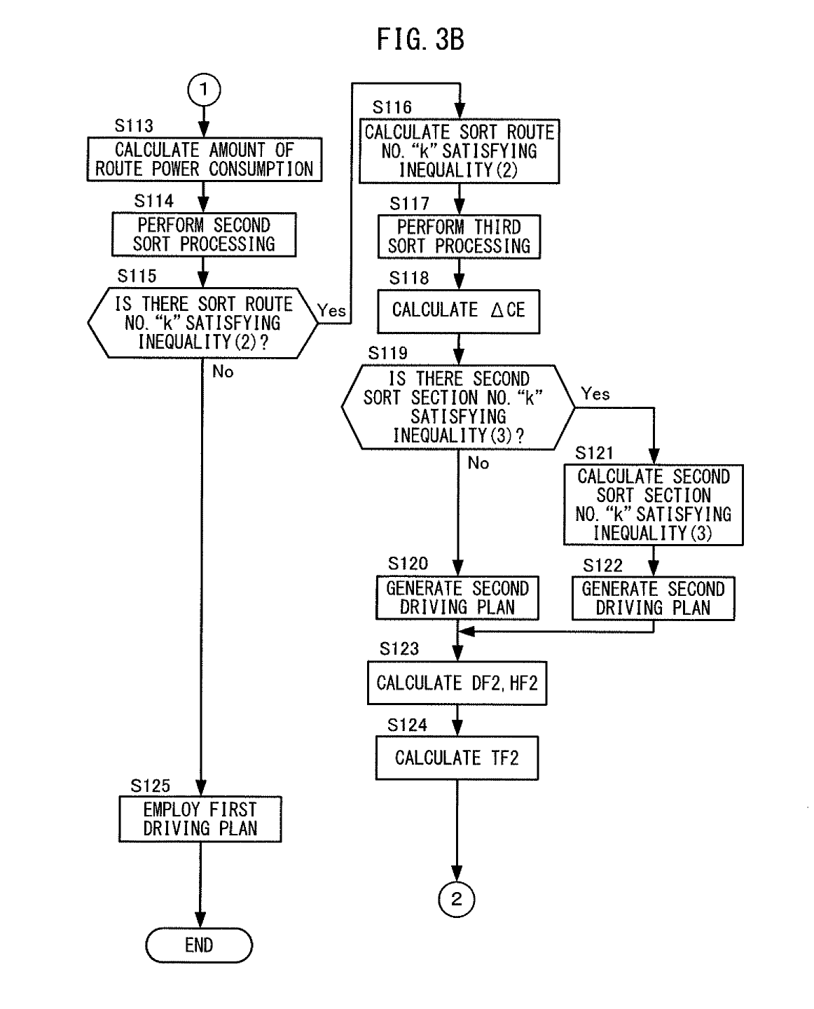

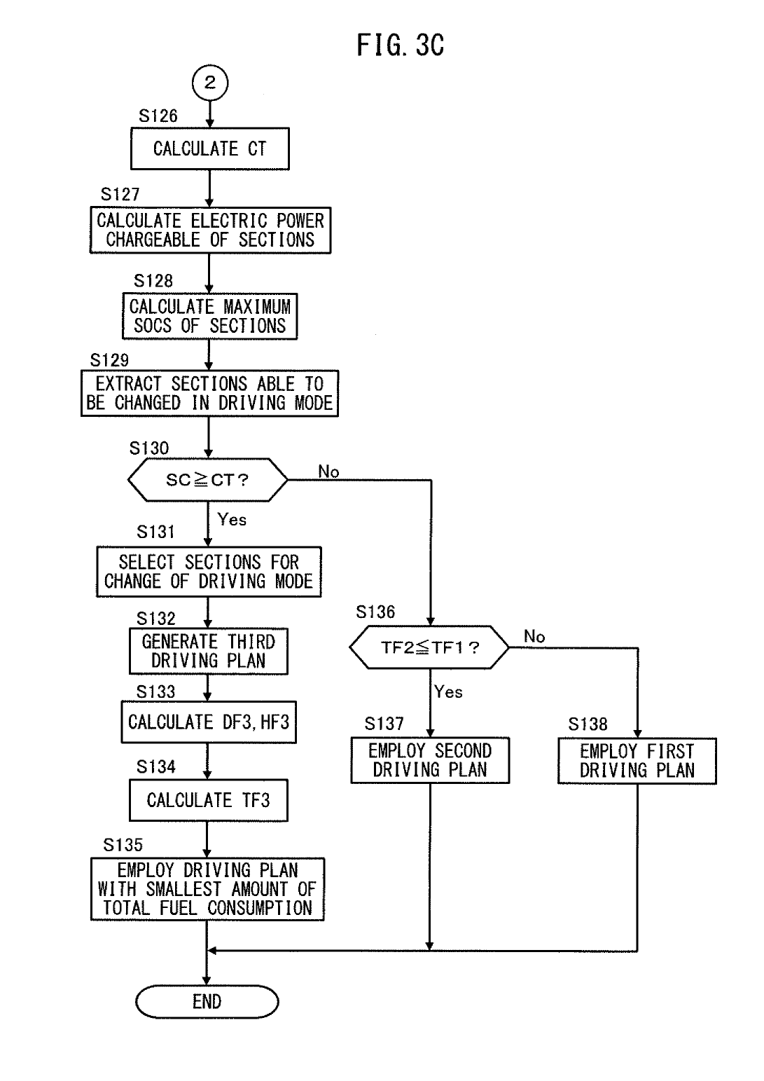

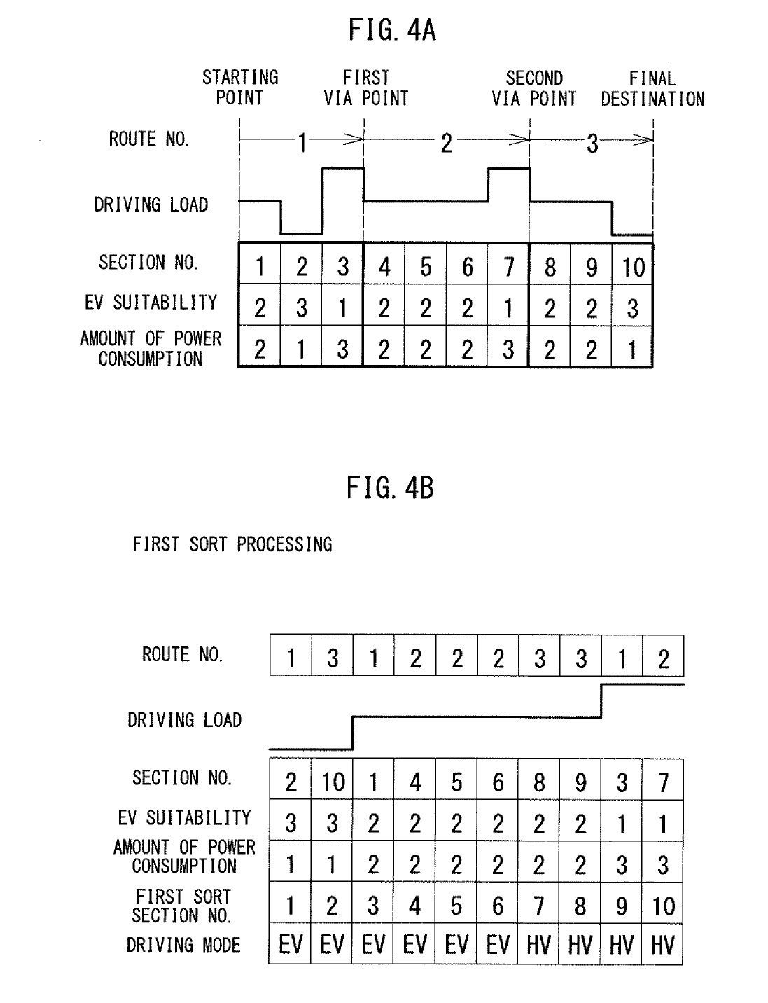

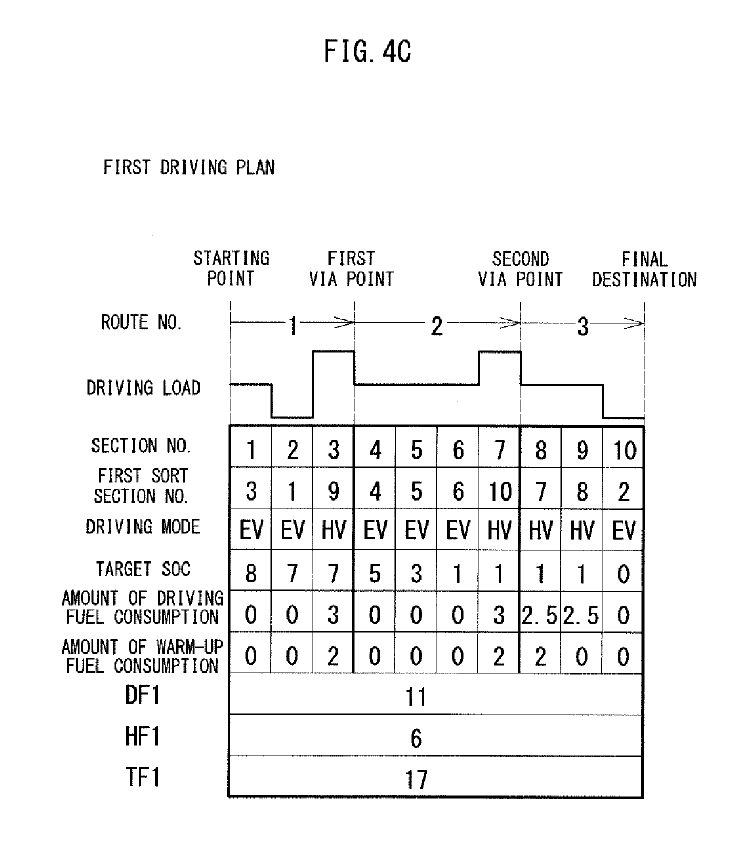

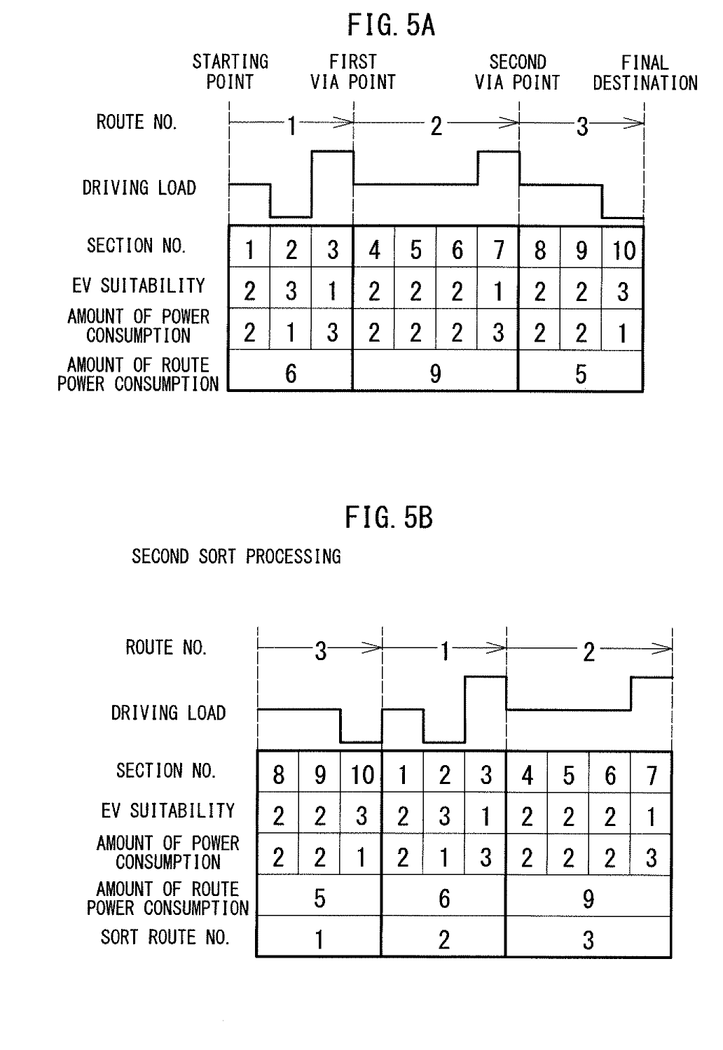

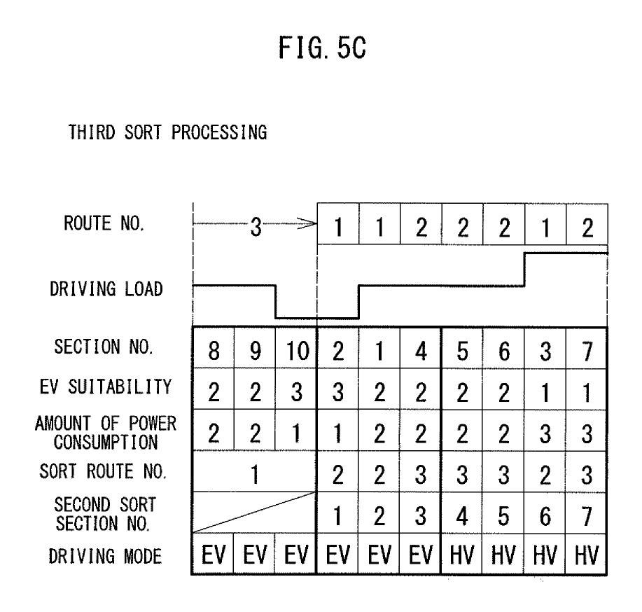

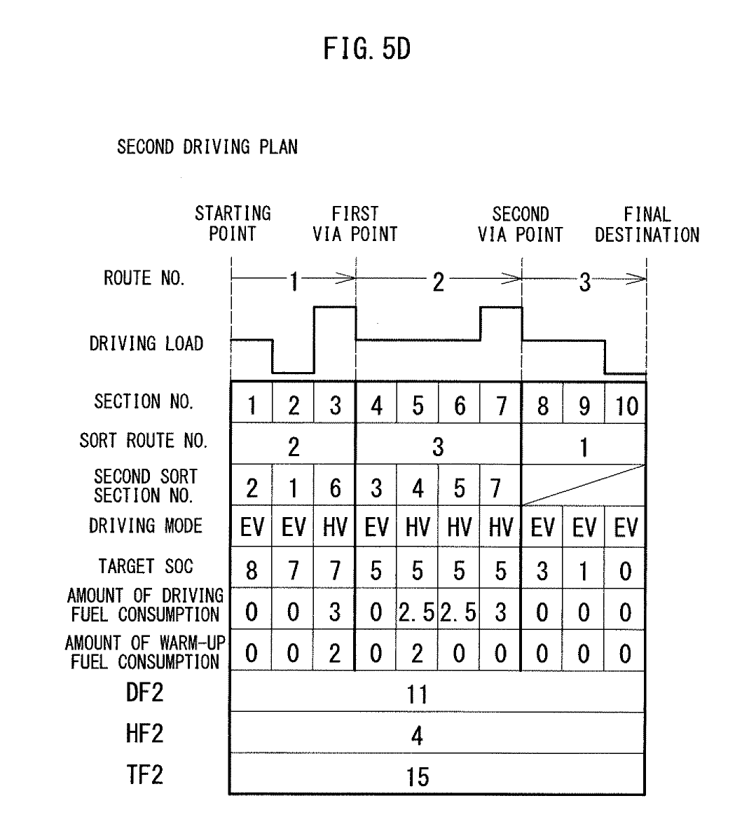

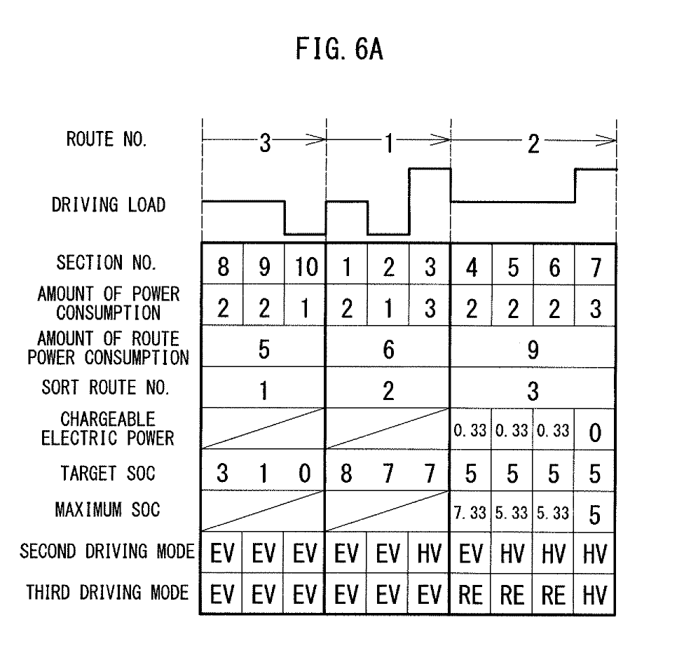

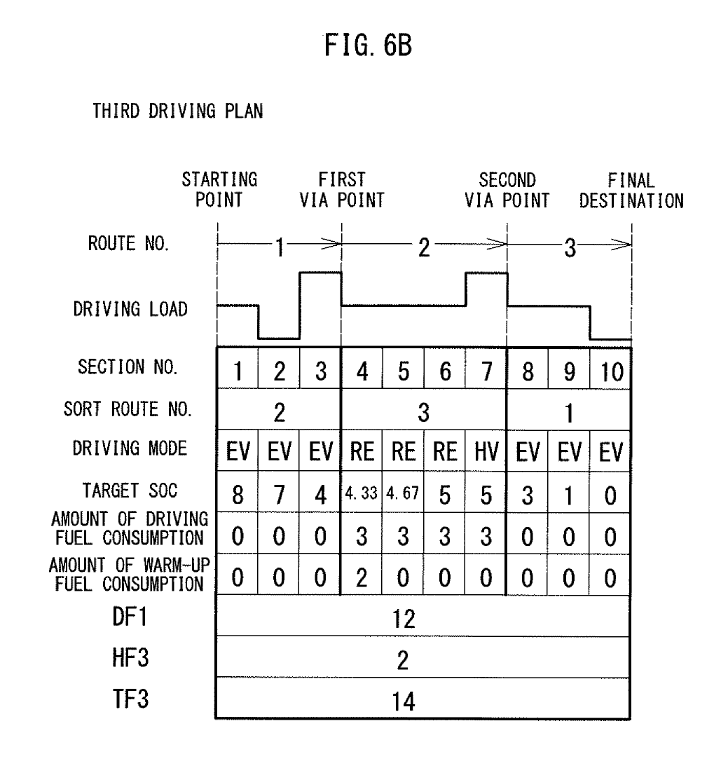

FIG. 3A to FIG. 3C are flow charts showing a control routine of processing for generating a driving plan in a first embodiment of the present invention. The present control routine is performed by the ECU 60. In the present control routine, a first driving plan, second driving plan, and third driving plan are generated and the driving plan with a smaller total of the amounts of fuel consumption is employed. FIG. 4A to FIG. 4C are views for explaining the generation of the first driving plan. FIG. 5A to FIG. 5D are views for explaining the generation of the second driving plan, and FIG. 6A and FIG. 6B are views for explaining the generation of the third driving plan.

At step S101 of FIG. 3A, the driving plan generating part 61, as shown in FIG. 4A, divides a driving route from a departure point to a final destination into a plurality of routes and divides each of the routes into pluralities of sections. A route has a via point as at least one of the starting point and end point. In the example of FIG. 4A, it is comprised of a first route from the departure point to a first via point, a second route from the first via point to a second via point, and a third route from the second via point to the final destination. The first route is divided into the three sections of a first section to a third section. The second route is divided into the four sections of a fourth section to a seventh section. The third route is divided into the three sections of an eighth section to a 10th section. The sections are determined based on the distances, positions of cross points, road IDs contained in map information of the map database 53, etc.

The departure point and the final destination are, for example, set to a main storage location of the vehicle 1 such as the home. Note that, departure point and the final destination do not necessarily have to be the same. For example, if there is a charging station with a high frequency of utilization, the home and charging station may be set as the departure point and the final destination or the home and charging station may be set as the final destination and departure point.

A via point is an end point of one trip. For example, it is set to a destination input by the driver to the navigation system 54 at the departure point. Further, if the vehicle 1 travels around a plurality of destinations set in advance, the destinations are set as via points. Further, if the vehicle 1 is used to commute to work, the workplace is set as a via point or if the vehicle is used to commute to school, the school is set as a via point. Note that, the navigation system 54 may be configured so that the driver can input the departure point, the final destination, and the via points.

Next, at step S102, the driving plan generating part 61 calculates the driving load of each of the sections based on the road information of the sections (for example, road gradients, speed limits, types of roads, etc.). The road information of the sections is acquired from the map database 53. Note that, the driving plan generating part 61 may calculate the driving load of each of the sections based on the driving logs of the sections.

The driving plan generating part 61 calculates the EV suitabilities of the sections based on the driving loads of the sections. In the present description, the EV suitability is expressed by a simplified numerical value. The EV suitability becomes higher the larger the numerical value.

Further, the driving plan generating part 61 calculates the amount of power consumption of the section based on the driving load and distance of the section. In the present description, the amount of power consumption is expressed by a simplified numerical value. The amount of power consumption becomes larger the larger the numerical value.

Next, at step S103, the driving plan generating part 61 calculates the amount of total power consumption TE when the vehicle 1 is being driven over an entire driving route by the EV mode based on the amounts of power consumption of the sections. The amount of total power consumption TE is the total of the amounts of power consumption of the sections.

Next, at step S104, the driving plan generating part 61 calculates the amount of electric power CE of the battery 20 able to be used in the EV mode and judges whether the amount of electric power CE is equal to or more than the amount of total power consumption TE. The driving plan generating part 61 calculates the amount of electric power CE based on the SOC of the battery 20 at the departure point. The higher the SOC of the battery 20, the larger the amount of electric power CE.

If at step S104 it is judged that the amount of electric power CE is equal to or more than the amount of total power consumption TE, the control routine proceeds to step S105. At step S105, the driving plan generating part 61 sets the driving modes of all of the sections to the EV mode. That is, the entire route is set to an EV route. After step S105, the present control routine ends.

On the other hand, if at step S 104 it is judged that the amount of electric power CE is less than the amount of total power consumption TE, the control routine proceeds to step S106. At step S106, the driving plan generating part 61, as shown in FIG. 4B, performs the first sort processing to rearrange the order of the sections.

In the first sort processing, the order of the sections is rearranged based on the EV suitability, the amount of power consumption, and the section no. Specifically, the sections are rearranged in the order of the highest EV suitability down. Further, if the EV suitability is equal, the sections are rearranged in the order of the smallest amount of power consumption up. Further, if the EV suitability and the amount of power consumption are equal, the sections are rearranged in the order of the smallest section no. up. Furthermore, the driving plan generating part 61 assigns a first sort section no. to each section in the rearranged order (i=1, . . . , n; in the example shown in FIG. 4B, n=10).

Next, at step S107, the driving Plan generating part 61 judges whether there is a first sort section no. “k” satisfying the following inequality (1):

DEₖCE≤DEₖ₊₁ (1)

Here, DEₖ is the total of the amounts of power consumption of the sections from the first sort section no. 1 to the first sort section no. “k”. DEₖ₊₁ is the total of the amounts of power consumption of the sections from the first sort section no. 1 to the first sort section no. k+1.

Specifically, the driving plan generating part 61 judges that there is no sort section no. “k” satisfying the inequality (1) if the amount of power consumption DE₁ of the section when the first sort section no. is 1 is larger than the amount of electric power CE calculated at step S104. On the other hand, the driving plan generating part 61 judges that there is a first sort section no. “k” satisfying the inequality (1) if the amount of power consumption DE₁ when the first sort section no. is 1 is equal to or less than the amount of electric power CE.

If at step S107 it is judged that there is no first sort section no. “k” satisfying the inequality (1), the control routine proceeds to step S108. At step S108, the driving plan generating part 61 sets the driving modes of all sections to the HV mode. After step S108, the present control routine ends. Note that, at step S108, the driving plan generating part 61 may set the driving mode of the section of the first sort section no. 1 to the EV mode and set the driving modes of the other sections to the HV mode. In this case, when the SOC of the battery 20 is less than the lower limit value at the section of the first sort section no. 1, the driving mode is changed from the EV mode to the HV mode. The lower limit value is preset considering deterioration of the battery 20 etc.

On the other hand, if at step S107 it is judged that there is a first sort section no. “k” satisfying the inequality (1), the control routine proceeds to step S109. At step S109, the driving plan generating part 61 calculates the first sort section no. “k” satisfying the inequality (1).

Next, at step S110, as shown in FIG. 4B, the driving plan generating part 61 sets the driving mode of the sections from the first sort section no. 1 to the first sort section no. “k” (in the example shown in FIG. 4B, k=6) to the EV mode and sets the driving mode of the sections from the sort section no. k+1 to the first sort section no. “n” to the HV mode. Further, the driving plan generating part 61, as shown in FIG. 4C, generates the first driving plan by rearranging the sections in the order of the section nos. and setting the target SOC of each of the sections corresponding to the driving modes.

Next, at step S111, as shown in FIG. 4C, the driving plan generating part 61 calculates the amount of fuel consumed due to driving over each of the sections (below, referred to as the “amount of driving fuel consumption”) and calculates an amount of first driving fuel consumption DF1 which is the total of the amounts of driving fuel consumption when the vehicle 1 is driven over an entire driving route based on the first driving plan. Note that, in an EV section where the driving mode is set to the EV mode, the amount of driving fuel consumption becomes zero, while in an HV section where the driving mode is set to the HV mode, the amount of driving fuel consumption becomes larger than zero. The driving plan generating part 61 calculates the amount of driving fuel consumption of the HV section based on the driving load and distance of the HV section.

Further, at step S111, the driving plan generating part 61 calculates the amount of fuel consumed for warming up the catalyst 43 at each of the sections (below, “amount of warm-up fuel consumption”) and calculates the amount of first warm-up fuel consumption HF1 which is the total of the amounts of warm-up fuel consumption when the vehicle 1 is driven over an entire driving route based on the first driving plan. The amount of first warm-up fuel consumption HF1 is calculated assuming the catalyst 43 is warmed up at only the initial HV section of the route.

Next, at step S112, the driving plan generating part 61 calculates the amount of first total fuel consumption TF1 which is the total of the amounts of fuel consumption when the vehicle 1 is driven over an entire driving route based on the first driving plan. The driving plan generating part 61 calculates the amount of first total fuel consumption TF1 as the total of the amount of first driving fuel consumption DF1 and the amount of first warm-up fuel consumption HF1 (TF1=DF1+HF1).

In the present description, the target SOC, amount of driving fuel consumption, amount of warm-up fuel consumption, amount of first driving fuel consumption DF1, amount of first warm-up fuel consumption HF1, and amount of first total fuel consumption TF1 are expressed by simplified numerical values. The parameters become larger the larger the numerical values. Further, in FIG. 4C, the target SOC is shown by the value at the end point of each section. At an EV section, the target SOC gradually becomes lower in that section. On the other hand, in an HV section, the target SOC is maintained constant.

Next, at step S113, as shown in FIG. 5A, the driving plan generating part 61 calculates the amount of power consumption when the vehicle 1 is driven over each of routes by the EV mode (below, referred to as “the amount of route power consumption”) based on the amounts of power consumption of the sections. The driving plan generating part 61 calculates the amount of route power consumption as the totals of the amounts of power consumption of the sections of the routes.

Next, at step S114, as shown in FIG. 5B, the driving plan generating part 61 performs second sort processing to rearrange the order of the routes. In the second sort processing, the order of the routes is rearranged based on the amounts of route power consumption. Specifically, the routes are rearranged in the order of the smallest amount of route power consumption up. Furthermore, the driving plan generating part 61 assigns a sort route no. to each route in the rearranged order (i=1, . . . , n; in the example shown in FIG. 5B, n=3).

Next, at step S115, the driving plan generating part 61 judges whether there is a sort section no, “k” satisfying the following inequality (2):

REₖ≤CE<REₖ₊₁ (2)

Here, REₖ is the total of the amounts of route power consumption of the routes from the sort route no. 1. to the sort route no. “k”. REₖ₊₁ is the total of the amounts of route power consumption of the routes from the sort route no. 1 to the sort route no. k+1.

Specifically, the driving plan generating part 61 judges that there is no sort route no. “k” satisfying the inequality (2) if the amount of route power consumption RE₁ of the route when the sort route no. is 1 is larger than the amount of electric power CE calculated at step S104. On the other hand, the driving plan generating part 61 judges that there is a sort route no. “k” satisfying the inequality (2) if the amount of route power consumption RE₁ is equal to or less than the amount of electric power CE.

If at step S115 it is judged that there is no sort route no. “k” satisfying the inequality (2), the control routine proceeds to step S125. At step S125, the driving plan generating part 61 employs the first driving plan as the final driving plan. After step S125, the present control routine ends.

On the other hand, if at step S115 it is judged that there is a sort route no, “k” satisfying the inequality (2), the control routine proceeds to step S116. At step S116, the driving plan generating part 61 calculates the sort route no. “k” satisfying the inequality (2).

Next, at step S117, as shown in FIG. 5C, the driving plan generating part 61 performs third sort processing on the sections of the routes from the sort route no. k+1 to the sort route no. “n” to rearrange the order of sections. In the example shown in FIG. 5C, the orders of the sections of the first route and second route are rearranged.

In the third sort processing, in the same way as the first sort processing, the order of the sections is rearranged based on the EV suitability, the amount of power consumption, and the section no. Specifically, the sections are rearranged in the order of the highest EV suitability down. Further, if the EV suitability is equal, the sections are rearranged in the order of the smallest amount of power consumption up. Further, if the EV suitability and the amount of power consumption are equal, the sections are rearranged in the order of the smallest section no. up. Furthermore, the driving plan generating part 61 assigns second sort section nos. to each section in the rearranged order (i=1, . . . , n; in the example shown in FIG. 5C, n=7).

Next, at step S118, the driving plan generating part 61 subtracts the total REₖ of the amounts of route power consumption when the sort route no. is “k” from the amount of electric power CE calculated at step S104 to thereby calculate the amount of excess electric power ΔCE of the battery 20 (ΔCE=CE−REₖ). The amount of excess electric power ΔCE is the amount of electric power of the battery 20 which can be used in the non-EV routes (in the example shown in FIG. 5C, the first route and second route).

Next, at step S119, the driving plan generating part 61 judges whether there is a second sort section no. “k” satisfying the following inequality (3):

EEₖ≤ΔCE<EEₖ₊₁ (3)

Here, EEₖ is the total of the amounts of power consumption of the sections from the second sort section no. 1 to the second sort section no. “k”. EEₖ₊₁ is the total of the amounts of power consumption of the sections from the second sort section no. 1 to the second sort section no. k+1.

Specifically, the driving plan generating part 61 judges that there is no second sort section no. “k” satisfying the inequality (3) if the amount of power consumption EE₁ when the second sort section no. is 1 is larger than the amount of electric power CE. On the other hand, the driving plan generating part 61 judges that there is a second sort section no. “k” satisfying the inequality (3) if the amount of power consumption EE₁ when the second sort section no. is 1 is equal to or less than the amount of electric power CE.

If at step S119 it is judged that there is no second sort section no. “k” satisfying the inequality (3), the control routine proceeds to step S120. At step S120, the driving plan generating part 61 sets the driving modes of all of the sections of the routes up to the sort route no. “k” to the EV mode and sets the driving modes of all of the sections of the routes from the sort route no. k+1 to the sort route no. “n” to the HV mode. Next, the driving plan generating part 61 rearranges the sections in the order of the section nos. and sets the target SOC of each of the sections corresponding to the driving modes to thereby generate a second driving plan.

On the other hand, if at step S119 it is judged that there is a second sort section no. “k” satisfying the inequality (3), the control routine proceeds to step S121. At step S121, the driving plan generating part 61 calculates the second sort section no. “k” satisfying the inequality (3).

Next, at step S122, as shown in FIG. SC, the driving plan generating part 61 sets the driving modes of all of the sections of the routes up to the sort route no. “k” (in the example of FIG. 5C, k=1) to the EV mode. Further, for the routes from the sort route no. k+1 to the sort route no. “n”, the driving plan generating part 61 sets the driving modes of the sections from the second sort section no. 1 to the second sort section no. “k” (in the example shown in FIG. 5C, k=3) to the EV mode and sets the driving modes of the sections from the second sort section no. k+1 to the second sort section no. “n” to the HV mode. Next, as shown in FIG. 5D, the driving plan generating part 61 rearranges the sections in the order of the section nos. and sets the target SOC of each of the sections to generate a second driving plan.

After step S120 or step S122, at step S123, as shown in FIG. 5D, the driving plan generating part 61 calculates the amount of driving fuel consumption of each of the sections and calculates the amount of second driving fuel consumption DF2 which is the total of the amounts of driving fuel consumption when the vehicle 1 is driven over an entire driving route based on the second driving plan. The driving plan generating part 61 calculates the amount of driving fuel consumption of the HV section based on the driving load and distance of the HV section. In the example shown in FIG. 4C and FIG. 5D, the amount of second driving fuel consumption DF2 is equal to the amount of first driving fuel consumption DF1.

Further, at step S123, as shown in FIG. 5D, the driving plan generating part 61 calculates the amount of warm-up fuel consumption of each of the sections and calculates the amount of second warm-up fuel consumption HF2 which is the total of the amounts of warm-up fuel consumption when the vehicle 1 is driven over an entire driving route based on the second driving plan. The amount of second warm-up fuel consumption HF2 is calculated assuming that the catalyst 43 is warmed up only in the initial HV section of the route. In the example shown in FIG. 4C and FIG. 5D, in the second driving plan, the number of times of warm-up of the catalyst 43 is decreased, so the amount of second warm-up fuel consumption HF2 is smaller than the amount of first warm-up fuel consumption HF1.

Next, at step S124, as shown in FIG. 5D, the driving plan generating part 61 calculates the amount of second total fuel consumption TF2 which is the total of the amounts of fuel consumption when the vehicle 1 is driven along the entire driving route based on the second driving plan. The driving plan generating part 61 calculates the amount of second total fuel consumption TF2 as the total of the amount of second driving fuel consumption DF2 and the amount of second warm-up fuel consumption HF2 (TF2=DF2+HF2). In the example shown in FIG. 4C and FIG. 5D, the amount of second total fuel consumption TF2 is smaller than the amount of first total fuel consumption TF1. In this case, in the second driving plan, compared with the first driving plan, the fuel efficiency of the vehicle 1 is improved.

Next, at step S126, the driving plan generating part 61 calculates the target charging amount CT which is the electric power required for making the route of the sort route no. k+1 an EV route. Specifically, the driving plan generating part 61 subtracts the amount of electric power CE from the total REₖ₊₁ of the amounts of route power consumption of the routes up to the sort route no. k+1 to thereby calculate the target charging amount CT (CT=REₖ₊₁−CE). The sort route no. “k” is calculated at step S116 while the amount of electric power CE is calculated at step S104. The route of the sort route no. k+1 is a route set to a non-EV route in the second driving plan.

Next, at step S127, as shown in FIG. 6A, the driving plan generating part 61 calculates the chargeable electric power of each of the sections of the routes (non-EV routes) from the sort route no. k+2 to the sort route no. “n”. In the example shown in FIG. 6A, the chargeable electric power of each of the sections of the second route is calculated. The chargeable electric power is the electric power which can be charged to the battery 20 when setting the driving mode to the RE mode and becomes larger the smaller the driving loads of the section.

Next, at step S128, as shown in FIG. 6A, the driving plan generating part 61 calculates the maximum SOC of each of the sections of the routes from the sort route no. k+2 to the sort route no. “n”. Specifically, the driving plan generating part 61 adds the chargeable electric power of the section to the maximum target SOC of the sections in the second driving plan to thereby calculate the maximum SOC. The maximum target SOC of a section becomes the target SOC at the starting point of the section except when the target SOC becomes higher in the section due to a downward slope etc.

Next, at step S129, the driving plan generating part 61 extracts the sections which can be Changed in driving mode. Specifically, the section in which maximum SOC calculated at step S128 is higher than the upper limit value of the SOC of the battery 20 is excluded from sections which can be changed in driving mode. Due to this, it is possible to prevent a target SOC from being set to a value higher than the upper limit value when making the sort route no. k+1 an EV route. The upper limit value is preset considering deterioration of the battery 20 etc. in the example shown in FIG. 6A, it is 10.

Further, all sections of the final route, that is, the route closest to the final destination, are excluded from the sections which can be changed in driving mode. By this, it is possible to prevent the target SOC from being set to less than the lower limit value when making the route of the sort route no. k+1 an EV route. In the example shown in FIG. 6A, the lower limit value is zero.

Next, at step S130, the driving plan generating part 61 judges whether the total SC of the chargeable electric powers of sections which can be changed in driving mode is equal to or more than the target charging amount CT. If it is judged that the total SC of the chargeable electric powers is equal to or more than the target charging amount CT, the control routine proceeds to step S131.

At step S131, the driving plan generating part 61 selects sections for change of driving mode. Specifically, a section with chargeable electric power larger than the target Charging amount CT or a plurality of sections with a total of chargeable electric powers larger than the target charging amount CT are selected as sections for change of driving mode.

Next, at step S132, as shown in FIG. 6A, the driving plan generating part 61 sets the driving modes of all sections of the routes up to the sort route no. k+1 (in the example shown in FIG. 6A, k=1) to the EV mode, sets the driving modes of the sections selected at step S131 (in the example shown in FIG. 6A, the fourth section, fifth section, and sixth section of the second route) to the RE mode, and sets the driving modes of the other sections to the RV mode. FIG. 6A shows the driving modes of the sections set at the second driving plan (second driving modes) and the driving modes of the sections set at the third driving plan (third driving modes). In the example shown in FIG. 6A, the driving mode of the third section of the first route is changed from the HV mode to the EV mode, the driving mode of the fourth section of the second route is changed from the EV mode to the RE mode, and the driving modes of the fifth section and the sixth section of the second route are changed from the HV mode to the RE mode. The driving plan generating part 61, as shown in FIG. 6B, rearranges the sections in the order of the section nos. to thereby generate a third driving plan.

Next, at step S133, as shown in FIG. 6B, the driving plan generating part 61 calculates the amount of driving fuel consumption of each of the sections and calculates the amount of third driving fuel consumption DF3 which is the total of the amount of driving fuel consumption while the vehicle 1 is being driven over an entire driving route based on the third driving plan. The driving plan generating part 61 calculates the amount of driving fuel consumption of the HV section based on the driving load and distance of the ITV section. Further, the driving plan generating part 61 calculates the amount of driving fuel consumption of the RE section based on the distance of the RE section in which the driving mode is set to the RE mode. In the example shown in FIG. 5D and FIG. 6B, in the third driving plan, the battery 20 is charged by the output of the internal combustion engine 40, so the amount of third warm-up fuel consumption HF3 is slightly greater than the amount of second warm-up fuel consumption HF2.

Further, at step S133, as shown in FIG. 6B, the driving plan generating part 61 calculates the amount of warm-up fuel consumption of each of the sections and calculates the amount of third warm-up fuel consumption HF3 which is the total of the amounts of warm-up fuel consumption when the vehicle 1 is being driven over an entire driving route based on the third driving plan. The amount of third warm-up fuel consumption HF3 is calculated assuming that the catalyst 43 is warmed up only at the initial HV section or RE section of each route. In the example shown in FIG. 5D and FIG. 6B, in the third driving plan, the number of times of warm-up of the catalyst 43 is further reduced, so the amount of third warm-up fuel consumption HF3 is smaller than amount of second warm-up fuel consumption HF2.

Next, at step S134, as shown in FIG. 6B, the driving plan generating part 61 calculates the amount of third total fuel consumption TF3 which is the total of the amounts of fuel consumption when the vehicle 1 is being driven over an entire driving route based on the third driving plan. The driving plan generating part 61 calculates the amount of third total fuel consumption TF3 as the total of the amount of third driving fuel consumption DF3 and the amount of third warm-up fuel consumption HF3 (TF3=DF3+HF3). In the example shown in FIG. 6B, in the third driving plan, the amount of reduction of the amount of warm-up fuel consumption due to the decrease of the number of times of warm-up of the catalyst 43 is larger than the amount of addition of the amount of driving fuel consumption due to changing the driving mode to the RE mode. For this reason, the amount of third total fuel consumption TF3 is smaller than the amount of second total fuel consumption TF2. In this case, in the third driving plan, the fuel efficiency of the vehicle 1 is improved compared with the second driving plan.

Next, at step S135, the driving plan generating part 61 compares the amount of first total fuel consumption TF1, amount of second total fuel consumption TF2, and amount of third total fuel consumption TF3 and employs the driving plan with the smallest amount of total consumed electric power as the final driving plan. In the example shown in FIG. 4C, FIG. 5D, and FIG. 6D, the amount of third total fuel consumption TF3 is the smallest, so the third driving plan is employed. After step S135, the present control routine ends.

On the other hand, if at step S130 it is judged that the total SC of the chargeable electric powers is less than the target charging amount CT, the control routine proceeds to step S136. At step S136, the driving plan generating part 61 judges whether amount of second total fuel consumption TF2 is equal to or less than the amount of first total fuel consumption TF1. If it is judged that the amount of second total fuel consumption TF2 is equal to or less than the amount of first total fuel consumption TF1, the control routine proceeds to step S137. At step S137, the driving plan generating part 61 employs the second driving plan as the final driving plan. After step S137, the present control routine ends.

On the other hand, if at step S136 it is judged that the amount of second total fuel consumption TF2 is greater than the amount of first total fuel consumption TF1, the control routine proceeds to step S138. At step S138, the driving plan generating part 61 employs the first driving plan as the final driving plan. After step S138, the present control routine ends.

Note that, if the third driving plan is generated, the third driving plan may be employed as the final driving plan without comparing the amount of first total fuel consumption TF1, amount of second total fuel consumption TF2, and amount of third total fuel consumption TF3, Further, in the generation of the third driving plan, unless the minimum SOC of the section become less than the lower limit value, the sections of the final route may be selected as sections for change of the driving mode.

Further, if at step S115 it is judged that there is no sort route no. “k” satisfying the inequality (2), the sort route no. “k” may be set to zero and the control routine may proceed to step S126. In this case, in the generation of the third driving plan, the routes set to the non-EV routes in the first driving plan are changed to EV routes.

Further, usually, in an HV section with a driving mode set to the HV mode, the target SOC is maintained constant. In this case, the output of the internal combustion engine 40 is used as driving-use power of the vehicle 1 and the battery 20 is not charged much at all. On the other hand, if the target SOC at the end point of an HV section is raised over the target SOC at the starting point of the HV section, the output of the internal combustion engine 40 is used to charge the battery 20 so that the SOC of the battery 20 approaches the target SOC. In this case, the engine load is made a value higher than the reference value set based on the driving load.

Therefore the driving plan generating part 61 may set the driving modes of some of the sections to the HV mode and calculate the amount of chargeable electric power as the total of the electric power which can be charged to the battery 20 when making the target SOC at the end point of the section higher than the target SOC at the starting point of the section. In this case, the chargeable electric power of the section becomes larger the smaller the driving load of the section. The sections are selected by a method similar to the sections for change of driving mode. Therefore, at step S132, the driving plan generating part 61 sets the driving modes of all sections of the routes up to the sort route no. k+1 to the EV mode, sets the driving modes of the other sections to the HV mode, and makes the target SOC at each of the end points of the sections selected at step S131 higher than the target SOC at each of the starting points of these sections.

### Second Embodiment

The control device of a hybrid vehicle according to a second embodiment is basically similar in configuration and control to the control device of a hybrid vehicle according to the first embodiment except for the points explained below. For this reason, below, the second embodiment of the present invention will be explained focusing on the parts different from the first embodiment.

As explained above, the battery 20 can be charged by regenerative energy. For this reason, for example, when there is a downward slope at a predetermined section on the driving route, the SOC of the battery 20 is restored by the regenerative energy at this section. However, in this second driving plan, the amount of electric power which can be charged to the battery 20 by regenerative energy is not considered. For this reason, sometimes the amount of electric power which can be charged to the battery 20 by regenerative energy can be allocated to a route set as a non-EV route in the second driving plan to thereby change this route to an EV route.

Therefore, in the second embodiment, when the driving plan generating part 61 generates the third driving plan, it calculates the amount of chargeable electric power as the total of the electric power which can be charged to the battery 20 by regenerative energy while the vehicle is being driven and sets the driving modes of all sections of at least one route to the EV mode based on the amount of chargeable electric power. At this time, the driving plan generating part 61 sets the driving modes of all sections of non-EV routes other than the routes set to EV routes in the second driving plan to the EV mode.

Specifically, the driving plan generating part 61 changes the first non-EV route to an EV route if the total of the total of the amounts of power consumption of the EV sections on all routes set to non-EV routes in the first driving plan or second driving plan and the amount of chargeable electric power is larger than the amount of electric power required for setting the driving modes of all sections of the first non-EV route set as a non-EV route to the EV mode in the first driving plan or second driving plan, that is, the amount of route power consumption of the first non-EV route.

<Processing for Generating Driving Plan>

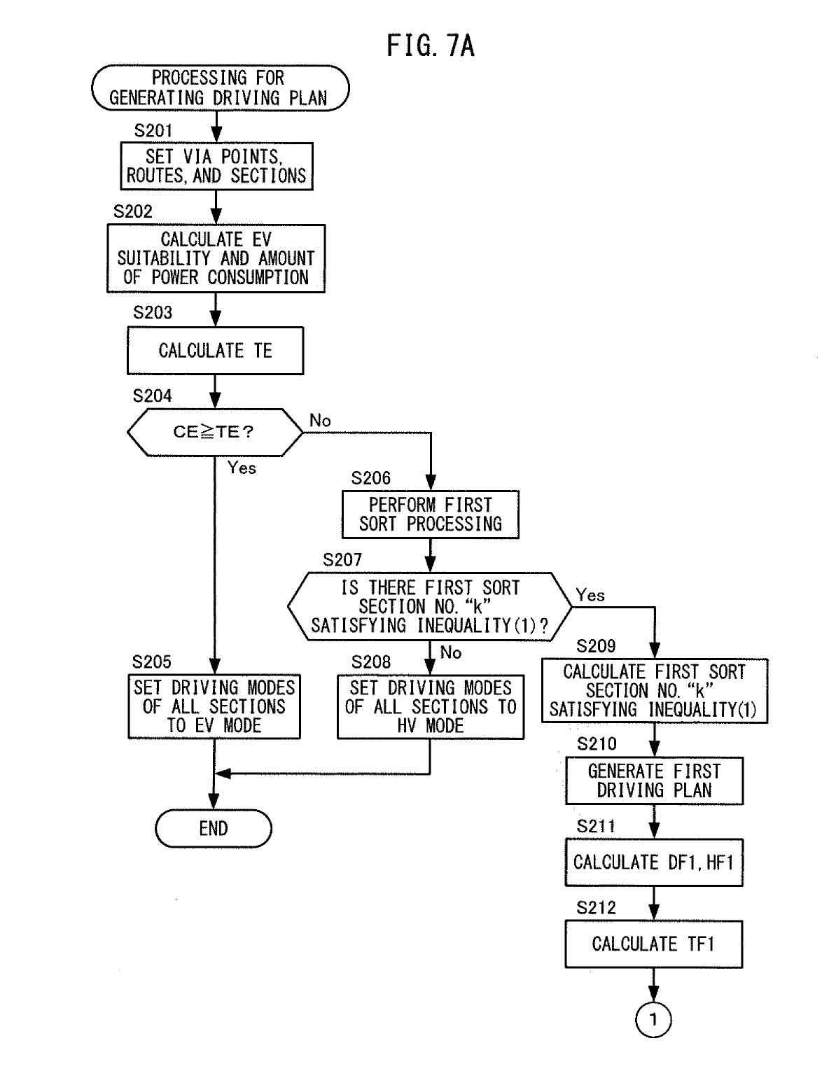

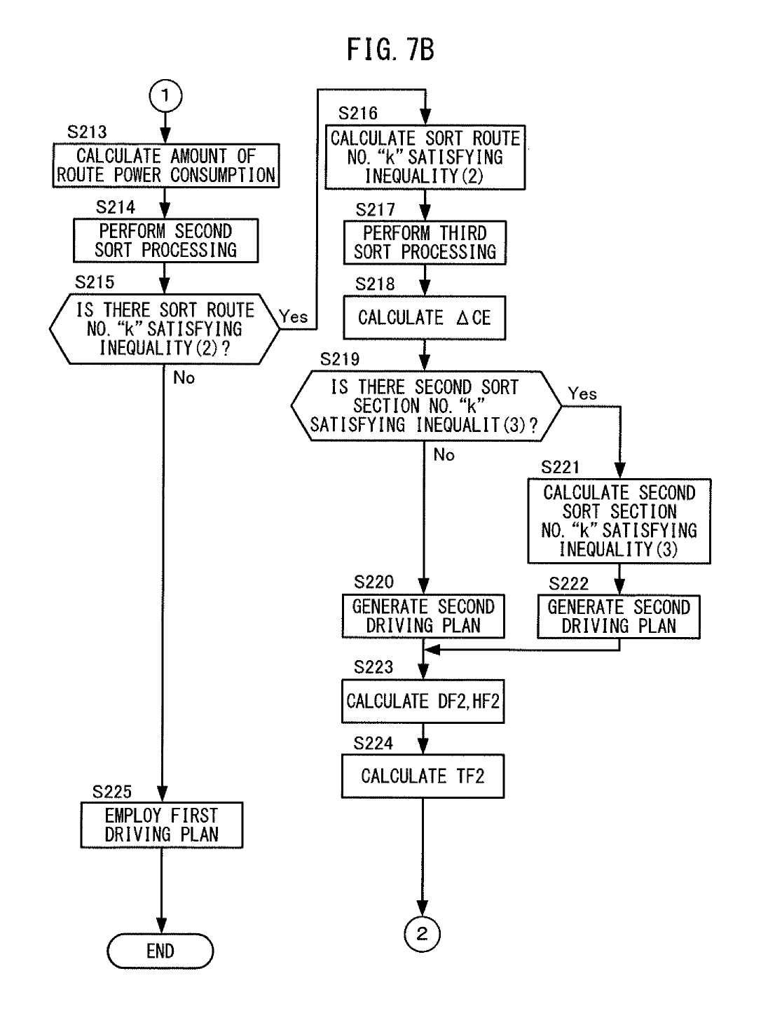

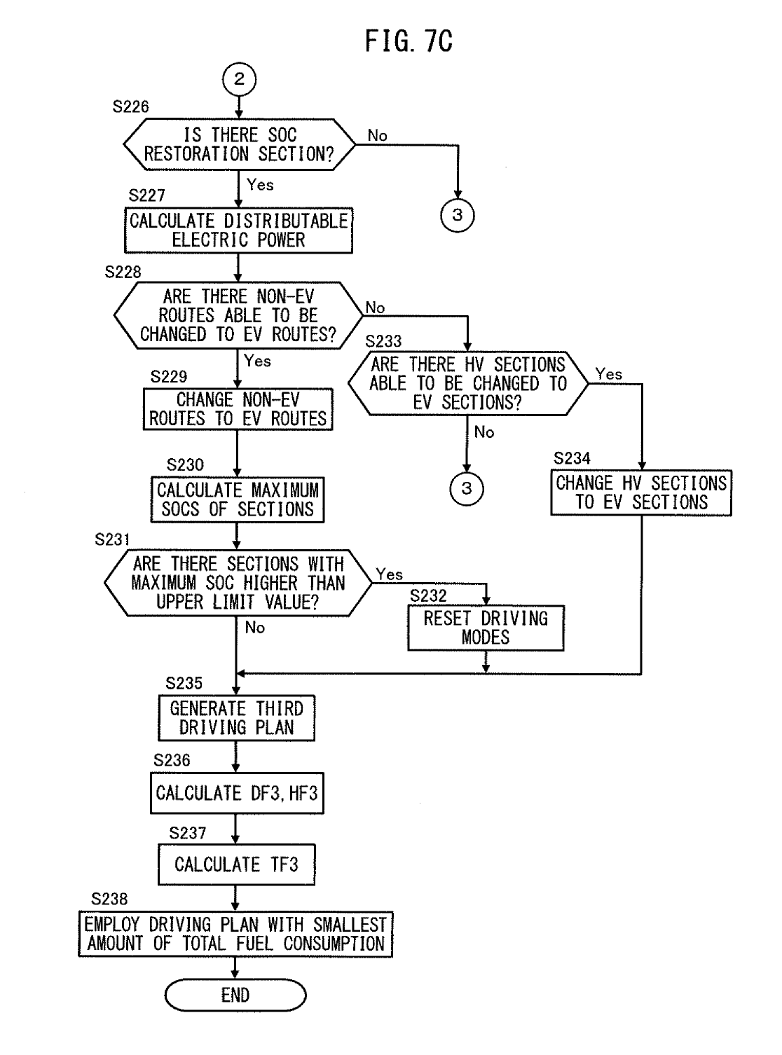

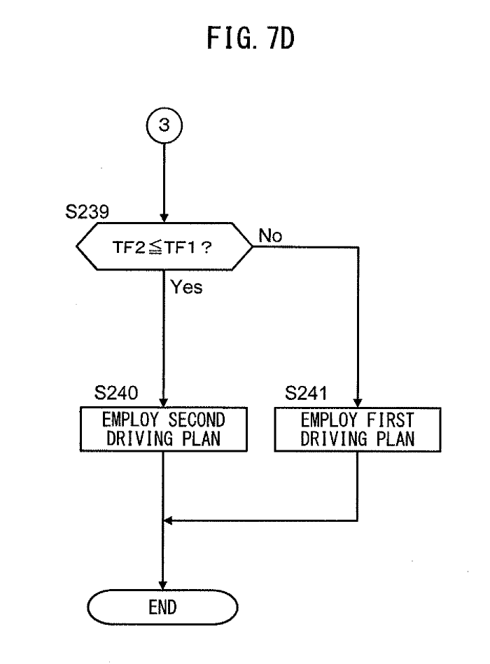

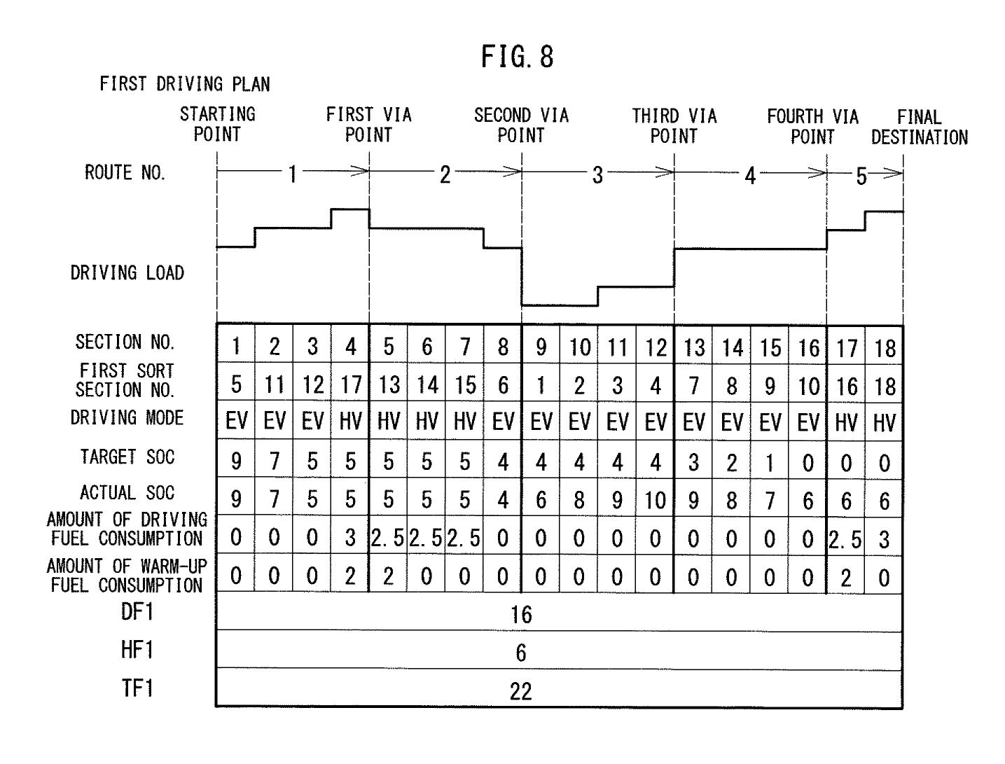

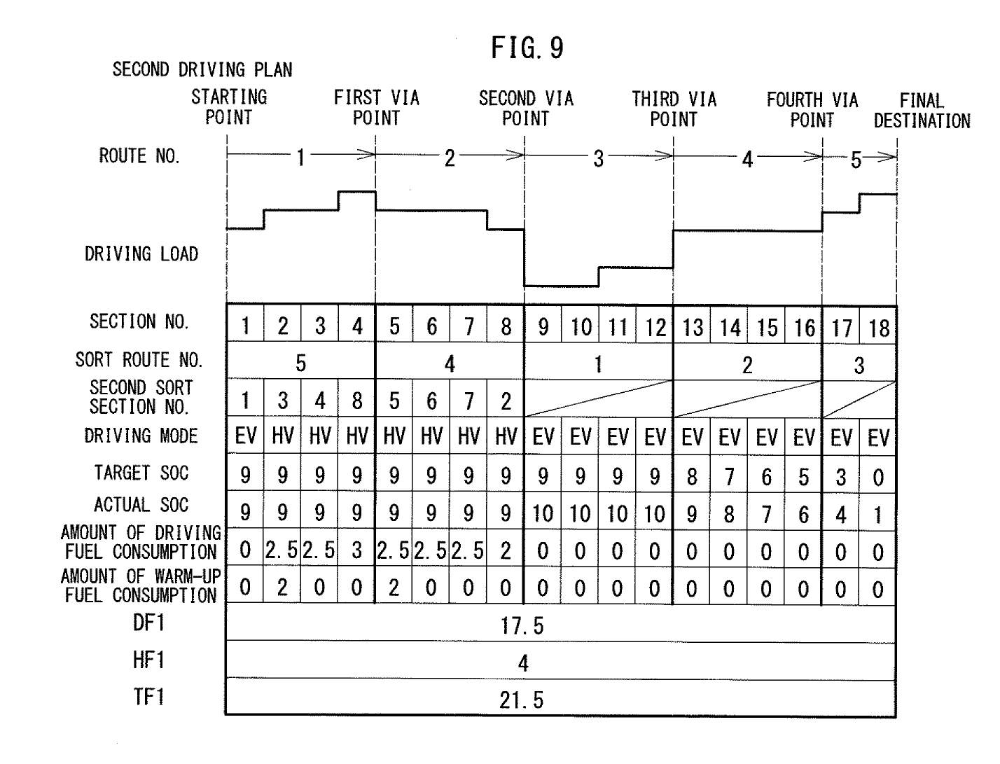

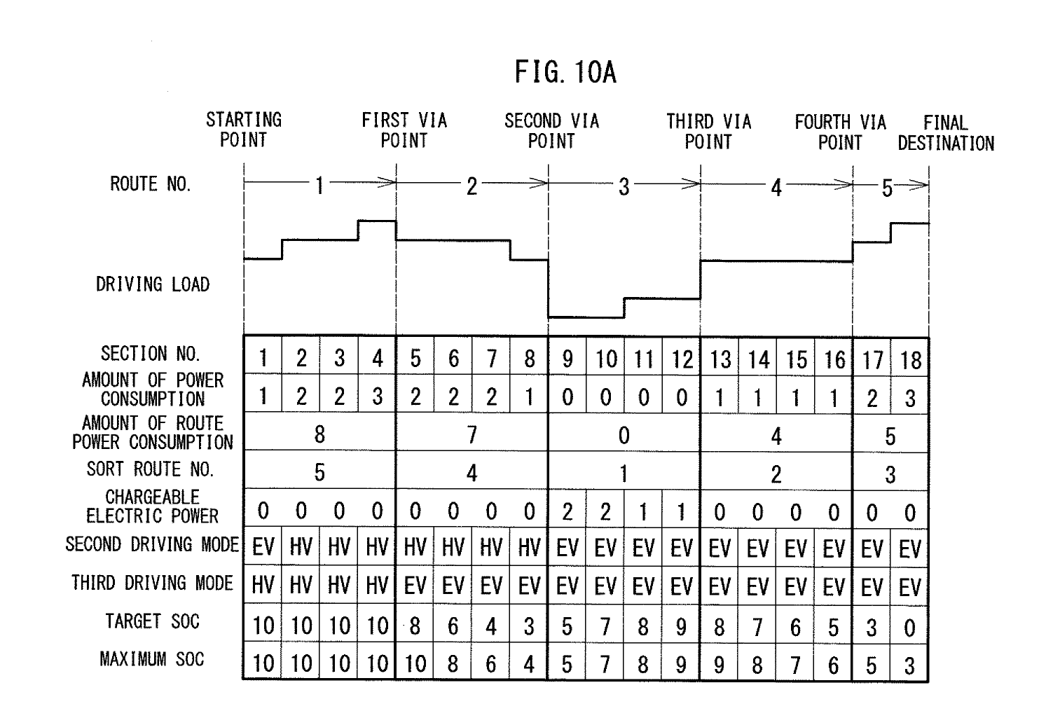

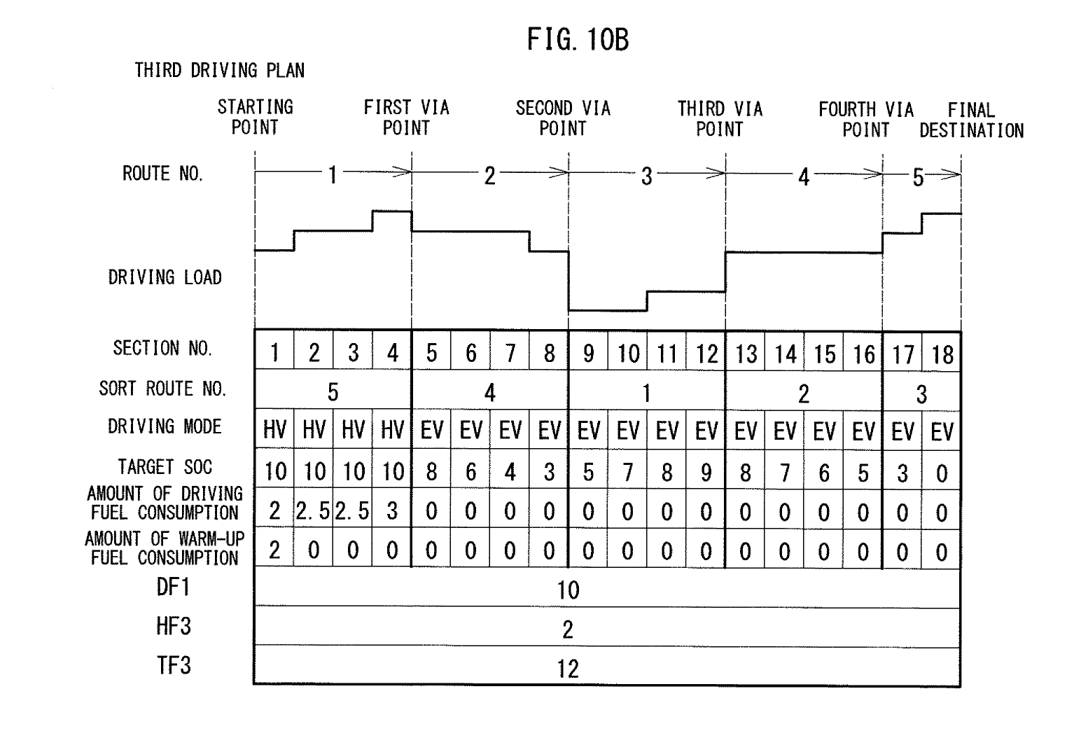

FIG. 7A to FIG. 7D are flow charts showing a control routine of the processing for generating a driving plan in the second embodiment of the present invention. The present control routine is performed by the ECU 60. In the present control routine, the first driving plan, second driving plan, and third driving plan are generated and the driving plan with the smallest amount of total fuel consumption is employed. FIG. 8 is a view for explaining the generation of a first driving plan. FIG. 9 is a view for explaining the generation of a second driving plan. FIG. 10A and FIG. 10B are views for explaining the generation of a third driving plan.

At step S101 of FIG. 7A, the driving plan generating part 61, as shown in FIG. 8, divides a driving route from a departure point to a final destination into a plurality of routes and further divides each of the routes into pluralities of sections. A route has a via point as at least one of the starting point and an end point. In the example of FIG. 7A, it is comprised of a first route from the departure point to a first via point, a second route from the first via point to a second via point, a third route from the second via point to a third via point, a fourth route from the third via point to a fourth via point, and a fifth route from the fourth via point to the final destination. The first route is divided into the four sections of a first section to a fourth section. The second route is divided into the four sections of a fifth section to an eighth section. The third route is divided into the four sections of a ninth section to a 12th section. The fourth route is divided into the four sections of a 13th section to a 16th section. The fifth route is divided into the two sections of a 17th section and an 18th section. The sections are determined based on the distances, positions of cross points, road IDs contained in map information of the map database 53, etc.

In the example shown in FIG. 7A, the driving loads of all of the sections of the third route are negative. For this reason, the battery 20 is charged by regenerative energy at the sections of the third route. Step S202 to step S209 are similar to step S102 to step S109 of FIG. 3A, so explanations will be omitted. After step S209, at step S210, as shown in FIG. 8, the driving plan generating part 61 generates a first driving plan.

At the first driving plan, the electric power charged to the battery 20 by regenerative energy is not considered. For this reason, as shown in FIG. 8, at the third route, the actual SOC of the battery 20 becomes higher than the target SOC and the actual SOC of the battery 20 when the vehicle 1 reaches its final destination becomes larger than the lower limit value.

Next, at step S211, as shown in FIG. 8, the driving plan generating part 61 calculates the amount of first driving fuel consumption DF1 and the amount of first warm-up fuel consumption HF1. Next, at step S212, as shown in FIG. 8, the driving plan generating part 61 calculates the amount of first total fuel consumption TF1 as the total of the amount of first driving fuel consumption DF1 and the amount of first warm-up fuel consumption HF1 (TF1=DF1+HF1).

Step S213 to step S221 are similar to step S113 to step S121 of FIG. 3B, so explanations will be omitted. After step S221, at step S222, as shown in FIG. 9, the driving plan generating part 61 generates a second driving plan.

At the second driving plan, the electric power charged to the battery 20 by regenerative energy is not considered. For this reason, as shown in FIG. 9, at the third route, the actual SOC of the battery 20 reaches the upper limit value. As a result, the battery 20 cannot be charged by regenerative energy and the regenerative energy becomes wasted. Further, the actual SOC of the battery 20 when the vehicle 1 reaches the final destination becomes larger than the lower limit value.

After step S220 or step S222, at step S223, as shown in FIG. 9, the driving plan generating part 61 calculates the amount of second driving fuel consumption DF2 and amount of second warm-up fuel consumption HF2. In the example shown in FIG. 8 and FIG. 9, the amount of second driving fuel consumption DF2 is larger than the amount of first driving fuel consumption DF1, and the amount of second warm-up fuel consumption HF2 is smaller than the amount of first warm-up fuel consumption HF1. Next, at step S224, as shown in FIG. 9, the driving plan generating part 61 calculates the amount of second total fuel consumption TF2 as the total of the amount of second driving fuel consumption DF2 and the amount of second warm-up fuel consumption HF2 (TF2=DF2+HF2). In the example shown in FIG. 8 and FIG. 9, the amount of second total fuel consumption TF2 is slightly smaller than the amount of first total fuel consumption TF1. In this case, in the second driving plan, the fuel efficiency of the vehicle 1 is improved compared with the first driving plan.

After step S224, at step S226, the driving plan generating part 61 judges whether there is an SOC restoration section in the driving route based on the road information of the sections (for example, road grade etc.). An “SOC restoration section” is a section where the SOC of the battery 20 will become higher due to regenerative energy and is, for example, a section including a downward slope.

If at step S226 it is judged that there is an SOC restoration section in the driving route, the control routine proceeds to step S227. At step S227, the driving plan generating part 61 calculates the distributable electric power. Specifically, the driving plan generating part 61 calculates the total of the amounts of power consumption of the EV sections of routes set to non-EV routes in the second driving plan and the total of the chargeable electric power of all of the sections, and calculates the total of these as the distributable electric power. The non-EV routes are the routes from the sort route no. k+1 to the sort route no. “n”. The sort route no. “k” is calculated at step S116. The chargeable electric power is the electric power which can be charged to the battery 20 by regenerative energy and is calculated based on the driving load of the section. The chargeable electric power becomes larger than zero when the driving load of the section is negative and becomes larger the larger the absolute value of the driving load of the section.

FIG. 10A shows the driving modes of the sections set at the second driving plan (second driving modes) and the driving modes of the sections set at the third driving plan (third driving modes). In the example of FIG. 10A, the sort route no. “k” is 3 and the non-EV routes are the first route and second route. Further, the total of the amounts of power consumption of the EV sections of the non-EV routes is 1 and the total of the chargeable electric power is 6. Therefore, the distributable electric power becomes 7.

Next, at step S228, the driving plan generating part 61 judges whether there is a non-EV route which can be changed to an EV route. The driving plan generating part 61 judges that there is a non-EV route which can be changed to an EV route if there is a non-EV section with a distributable electric power of the amount of route power consumption or more. On the other hand, the driving plan generating part 61 judges that there is no non-EV route which can be changed to an EV route if there is no non-EV section with a distributable electric power of the amount of route power consumption or more.

If at step S228 it is judged that there is a non-EV route which can be changed to an EV route, the control routine proceeds to step S229. At step S229, the driving plan generating part 61 changes the non-EV route which can be changed to an EV route to an EV route. That is, the driving plan generating part 61 sets the driving modes of all sections of the non-EV route which can be changed to an EV route to the EV mode. Note that, if a plurality of non-EV routes can be changed to EV routes, they are changed to EV routes in the order from the non-EV route with the smallest amount of route power consumption up. Further, the driving plan generating part 61 sets the driving modes of all sections of other non-EV routes to the HV mode. In the example shown in FIG. 10A, the driving modes of all sections of the second route are changed from the HV mode to the EV mode and the driving mode of the first section of the first route is changed from the EV mode to the HV mode.

At step S230, as shown in FIG. 10A, the driving plan generating part 61 calculates the maximum SOC of each of the sections while considering the amount of electric power charged to the battery 20 by regenerative energy. At the SOC restoration section, the target SOC at the end point of the section become the maximum SOC. On the other hand, at section other than SOC restoration section, the target SOC at the starting point of the section becomes the maximum SOCs except when the target SOCs in the sections becomes higher due to a downward slope etc.

Next, at step S231, the driving plan generating part 61 judges whether there is a section with a maximum SOC higher than the upper limit value of the SOC of battery 20. If at step S231 it is judged that there is no section with a maximum SOC higher than the upper limit value, the control routine proceeds to step S235. At step S235, as shown in FIG. 10B, the driving plan generating part 61 generates a third driving plan using the changed driving modes.

On the other hand, if at step S231 it is judged that there is a section where the maximum SOC is higher than the upper limit value, the control routine proceeds to step S232. At step S232, the driving plan generating part 61 resets the driving mode. Specifically, the driving plan generating part 61 changes HV sections before the section where the maximum SOC is higher than the upper limit value to EV sections. At this time, the HV sections are changed to EV sections in order from the HV sections with the smallest amount of power consumption up. Further, in order to prevent the target SOC from becoming less than the lower limit value, EV sections after the section where the maximum SOC is higher than the upper limit value are changed to HV sections. After step S232, the control routine proceeds to step S235. At step S235, the driving plan generating part 61 uses the changed driving modes to generate the third driving plan.

Further, if at step S228 it is judged that there are no non-EV route which can be changed to an EV route, the control routine proceeds to step S233. At step S233, the driving plan generating part 61 judges whether there is a HV section which can be changed to EV section using the chargeable electric power. If it is judged that there are HV sections which can be changed to EV sections, the control routine proceeds to step S234. At step S234, the driving plan generating part 61 changes the HV sections which can be changed to EV sections to EV sections. At this time, the HV sections are changed to EV sections in order from the section with the smallest amount of power consumption up. After step S234, the control routine proceeds to step S235. At step S235, the driving plan generating part 61 uses the changed driving modes to generate the third driving plan.

After step S235, at step S236, as shown in FIG. 10B, the driving plan generating part 61 calculates an amount of third driving fuel consumption DF3 and an amount of third warm-up fuel consumption HF3, Next, at step S237, as shown in FIG. 10B, the driving plan generating part 61 calculates an amount of third total fuel consumption TF3 as a total of the amount of third driving fuel consumption DF3 and the amount of third warm-up fuel consumption HF3 (TF3=DF3+HF3).

Next, at step S238, the driving plan generating part 61 compares the amount of first total fuel consumption TF1, the amount of second total fuel consumption TF2, and the amount of third total fuel consumption TF3 and employs the driving plan with the smallest amount of total consumed electric power as the final driving plan. In the example shown in FIG. 8, FIG. 9, and FIG. 10B, the amount of third total fuel consumption TF3 is the smallest, so the third driving plan is employed. After step S238, the present control routine ends.

Further, if at step S226 it is judged that there is no SOC restoration section or if at step S233 it is judged that there is no HV section able to be changed to an EV section, the control routine proceeds to step S239. At step S239, the driving plan generating part 61 judges whether the amount of second total fuel consumption TF2 is equal to or less than the amount of first total fuel consumption TF1. If it is judged that the amount of second total fuel consumption TF2 is equal to or less than the amount of first total fuel consumption TF1, the control routine proceeds to step S240. At step S240, the driving plan generating part 61 employs the second driving plan as the final driving plan. After step S240, the present control routine ends.

On the other hand, if at step S239 it is judged that amount of second total fuel consumption TF2 is larger than the amount of first total fuel consumption TF1, the control routine proceeds to step S241. At step S241, the driving plan generating part 61 employs the first driving plan as the final driving plan. After step S241, the present control routine ends.

Note that, if the third driving plan is generated, the third driving plan may be employed as the final driving plan without comparing the amount of first total fuel consumption TF1, the amount of second total fuel consumption TF2, and the amount of third total fuel consumption TF3. Further, if at step S215 it is judged that there is no sort route no. “k” satisfying the inequality (2), the control routine may proceed to step S226. In this case, in the generation of the third driving plan, the driving modes set at the first driving plan are changed.

### Third Embodiment

The control device of a hybrid vehicle according to a third embodiment is basically similar in configuration and control to the control device of a hybrid vehicle according to the first embodiment except for the points explained below. For this reason, below, the third embodiment of the present invention will be explained focusing on the parts different from the first embodiment.

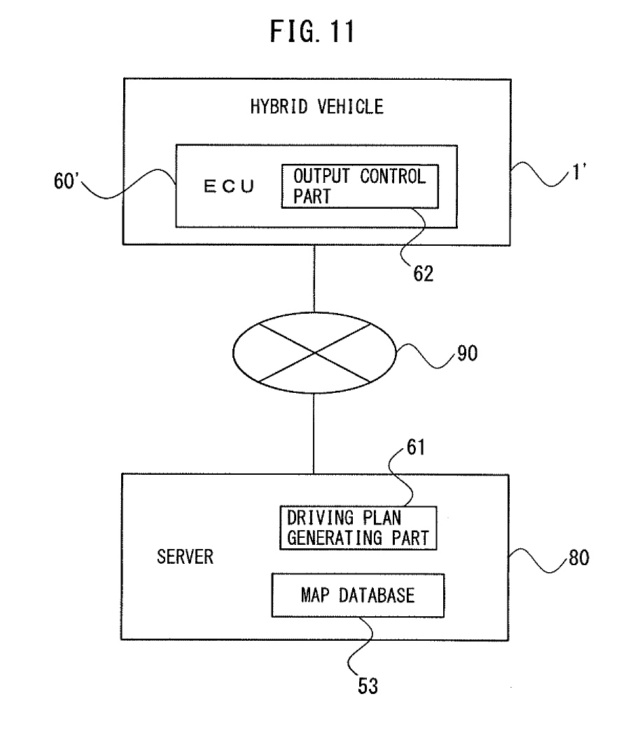

FIG. 11 is a block diagram schematically showing the configuration of the control device of a hybrid vehicle according to the third embodiment of the present invention. In the third embodiment, the control device of a hybrid vehicle is comprised of the ECU 60′ and server 80. The ECU 60′ and server 80 are respectively provided with communication interfaces and can communicate with each other through a network 90. Note that, the server 80 can communicate with not only the vehicle 1′, but also a plurality of other vehicles.

The server 80 is provided with, in addition to a communication interface, a central processing unit (CPU), a memory like a random access memory (RAM), a hard disk drive, etc. The server 80 runs a program stored in the hard disk drive etc., to function as the driving plan generating part 61. Further, the server 80 is provided with a map database 53, and the driving plan generating part 61 can obtain road information from the map database 53. On the other hand, the ECU 60′ runs a program stored in the memory etc., to function as the output control part 62.

In the third embodiment, instead of the ECU 60′ of the vehicle 1′, a driving plan is generated by the server 80. For this reason, it is possible to reduce the processing load of the ECU 60′ and in turn possible to reduce the manufacturing cost of the ECU 60′. Note that, in the third embodiment as well, in the same way as the first embodiment, the control routine of the processing for generating a driving plan of FIG. 3A to FIG. 3C is executed.

### Other Embodiments

Above, preferred embodiments of the present invention were explained, but the present invention is not limited to these embodiments and can be corrected and changed in various ways within the language of the claims.

For example, at the exhaust passage 41 of the internal combustion engine 40, two or more catalysts may be provided. Further, the first motor-generator 12 may be a generator not functioning as a motor. Further, in the first embodiment and the second embodiment, the second motor-generator 16 may be a motor not functioning as a generator.

Further, the vehicle 1 is a so-called “series-parallel type” hybrid vehicle. However, the vehicle 1 may be a so-called “series type”, “parallel type”, or other type of hybrid vehicle. Further, the vehicle 1 need not be a plug-in hybrid vehicle. That is, the battery 20 need not be charged by the outside power source 70.

Further, the second embodiment may be combined with the third embodiment, in the second embodiment, the server 80 may function as the driving plan generating part 61.

### REFERENCE SIGNS LIST

1, 1′ hybrid vehicle
16 second motor-generator
20 battery
40 internal combustion engine
41 exhaust passage
43 catalyst
60, 60′ electronic control unit (ECU)
61 driving plan generating part
62 output control part

1. A control device of a hybrid vehicle for controlling a hybrid vehicle comprising an internal combustion engine in which a catalyst is provided in an exhaust passage, a motor, and a battery supplying electric power to the motor and able to be charged by output of the internal combustion engine,
the control device of a hybrid vehicle comprising:
a driving plan generating part configured to set in advance a driving mode when the hybrid vehicle is being driven; and
an output control part configured to control outputs of the internal combustion engine and the motor based on the driving mode, wherein
if the hybrid vehicle is being driven from a departure point through at least one via point to a final destination, the driving plan generating part is configured to divide a plurality of routes each having a via point as at least one of a starting point and an end point into pluralities of sections, calculate an amount of electric power chargeable to the battery while the hybrid vehicle is being driven, and set driving modes of all sections of at least one route to an EV mode in which the internal combustion engine is stopped and drive use power is output by only the motor, based on the amount of electric power.

2. The control device of a hybrid vehicle according to claim 1, wherein the driving plan generating part is configured to set the driving modes of all sections of at least one route to the EV mode based on a state of charge of the battery at the departure point, and set to the EV mode the driving modes of all sections of routes other than the routes in which the driving modes of all sections are set to the EV mode, based on the amount of electric power.

3. The control device of a hybrid vehicle according to claim 1, wherein the driving plan generating part is configured to calculate the amount of electric power as a total of the electric power able to be charged to the battery by output of the internal combustion engine while the hybrid vehicle is being driven.

4. The control device of a hybrid vehicle according to claim 2, wherein the driving plan generating part is configured to calculate the amount of electric power as a total of the electric power able to be charged to the battery by output of the internal combustion engine while the hybrid vehicle is being driven.

5. The control device of a hybrid vehicle according to claim 3, wherein the driving plan generating part is configured to calculate the amount of electric power as a total of the electric power chargeable to the battery when setting the driving modes of some of the sections to an RE mode where the internal combustion engine is operated so as to charge the battery and the engine load is maintained at a predetermined value.

6. The control device of a hybrid vehicle according to claim 4, wherein the driving plan generating part is configured to calculate the amount of electric power as a total of the electric power chargeable to the battery when setting the driving modes of some of the sections to an RE mode where the internal combustion engine is operated so as to charge the battery and the engine load is maintained at a predetermined value.

7. The control device of a hybrid vehicle according to claim 3, wherein the driving plan generating part is configured to set the driving modes of some of the sections to an HV mode where drive-use power is output by the internal combustion engine and the motor and the outputs of the internal combustion engine and the motor are controlled so that the SOC of the battery approaches a target state of charge, and calculate the amount of electric power as a total of electric power chargeable to the battery when making the target state of charge at end points of the sections higher than the target state of charge at starting points of the sections.

8. The control device of a hybrid vehicle according to claim 4, wherein the driving plan generating part is configured to set the driving modes of some of the sections to an HV mode where drive-use power is output by the internal combustion engine and the motor and the outputs of the internal combustion engine and the motor are controlled so that the SOC of the battery approaches a target state of charge, and calculate the amount of electric power as a total of electric power chargeable to the battery when making the target state of charge at end points of the sections higher than the target state of charge at starting points of the sections.

9. The control device of a hybrid vehicle according to claim 1, wherein
the battery can be charged by regenerative energy, and
the driving plan generating part is configured to calculate the amount of electric power as a total of the electric power chargeable to the battery by regenerative energy while the hybrid vehicle is being driven.

10. The control device of a hybrid vehicle according to claim 2, wherein
the battery can be charged by regenerative energy, and
the driving plan generating part is configured to calculate the amount of electric power as a total of the electric power chargeable to the battery by regenerative energy while the hybrid vehicle is being driven.

11. The control device of a hybrid vehicle according to claim 1, wherein
the driving plan generating part is configured to generate a plurality of driving plans with different numbers of routes in which driving modes of all sections are set to the EV mode, and
the output control part is configured to control outputs of the internal combustion engine and the motor based on a driving plan where the amount of fuel consumed at the internal combustion engine becomes the smallest.

12. The control device of a hybrid vehicle according to claim 2, wherein
the driving plan generating part is configured to generate a plurality of driving plans with different numbers of routes in which driving modes of all sections are set to the EV mode, and
the output control part is configured to control outputs of the internal combustion engine and the motor based on a driving plan where the amount of fuel consumed at the internal combustion engine becomes the smallest.

13. The control device of a hybrid vehicle according to claim 3, wherein
the driving plan generating part is configured to generate a plurality of driving plans with different numbers of routes in which driving modes of all sections are set to the EV mode, and
the output control part is configured to control outputs of the internal combustion engine and the motor based on a driving plan where the amount of fuel consumed at the internal combustion engine becomes the smallest.

14. The control device of a hybrid vehicle according to claim 4, wherein
the driving plan generating part is configured to generate a plurality of driving plans with different numbers of routes in which driving modes of all sections are set to the EV mode, and
the output control part is configured to control outputs of the internal combustion engine and the motor based on a driving plan where the amount of fuel consumed at the internal combustion engine becomes the smallest.

15. The control device of a hybrid vehicle according to claim 5, wherein
the driving plan generating part is configured to generate a plurality of driving plans with different numbers of routes in which driving modes of all sections are set to the EV mode, and
the output control part is configured to control outputs of the internal combustion engine and the motor based on a driving plan where the amount of fuel consumed at the internal combustion engine becomes the smallest.

16. The control device of a hybrid vehicle according to claim 6, wherein
the driving plan generating part is configured to generate a plurality of driving plans with different numbers of routes in which driving modes of all sections are set to the EV mode, and
the output control part is configured to control outputs of the internal combustion engine and the motor based on a driving plan where the amount of fuel consumed at the internal combustion engine becomes the smallest.

17. The control device of a hybrid vehicle according to claim 7, wherein
the driving plan generating part is configured to generate a plurality of driving plans with different numbers of routes in which driving modes of all sections are set to the EV mode, and
the output control part is configured to control outputs of the internal combustion engine and the motor based on a driving plan where the amount of fuel consumed at the internal combustion engine becomes the smallest.

18. The control device of a hybrid vehicle according to claim 8, wherein
the driving plan generating part is configured to generate a plurality of driving plans with different numbers of routes in which driving modes of all sections are set to the EV mode, and
the output control part is configured to control outputs of the internal combustion engine and the motor based on a driving plan where the amount of fuel consumed at the internal combustion engine becomes the smallest.

19. The control device of a hybrid vehicle according to claim 9, wherein
the driving plan generating part is configured to generate a plurality of driving plans with different numbers of routes in which driving modes of all sections are set to the EV mode, and
the output control part is configured to control outputs of the internal combustion engine and the motor based on a driving plan where the amount of fuel consumed at the internal combustion engine becomes the smallest.

20. A control device of a hybrid vehicle for controlling a hybrid vehicle comprising an internal combustion engine in which a catalyst is provided in an exhaust passage, a motor, and a battery supplying electric power to the motor and able to be charged by output of the internal combustion engine, wherein
the control device of a hybrid vehicle is configured to:
set in advance a driving mode when the hybrid vehicle is being driven;
control outputs of the internal combustion engine and the motor based on the driving mode; and
if the hybrid vehicle is being driven from a departure point through at least one via point to a final destination, divide a plurality of routes each having a via point as at least one of a starting point and an end point into pluralities of sections, calculate an amount of electric power chargeable to the battery while the hybrid vehicle is being driven, and set driving modes of all sections of at least one route to an EV mode in which the internal combustion engine is stopped and drive use power is output by only the motor, based on the amount of electric power.
